(19) United States
(12) Patent Application Publication
(10) Pub. No.: US 2026/0085809 A1
(43) Pub. Date: Mar. 26, 2026

(54) LAMP POWERED BY MAINS POWER

(71) Applicant: JIANGMEN CITY SHENGDA LIGHTING CO., LTD., JIANGMEN, GUANGDONG (CN)

(72) Inventor: XIAOJUN XU, JIANGMEN (CN)

(21) Appl. No.: 19/405,600

(22) Filed: Dec. 2, 2025

Related U.S. Application Data
(63) Continuation-in-part of application No. 19/260,379, filed on Jul. 4, 2025.
Application No. 19/260,379 is a continuation-in-part of application No. 18/512,040, filed on Nov. 17, 2023, now Pat. No. 12,392,460.

(30) Foreign Application Priority Data
Oct. 23, 2023 (CN) 202311378975.3
Sep. 25, 2025 (CN) 202522074030.3
Oct. 9, 2025 (CN) 202522140927.1

(51) Int. Cl. F21V 1/00; F21S 4/10; F21S 8/08; F21V 17/12; F21V 19/00; F21V 21/08; F21W 131/10; F21Y 115/10

(52) U.S. Cl. CPC F21V 1/00; F21S 8/081; F21V 17/12; F21V 19/0025; F21S 4/10; F21V 21/0824; F21W 2131/10; F21Y 2115/10

(57) ABSTRACT

A lamp powered by mains power includes at least one light-emitting body (4200), at least one lampshade (4300), and at least one connecting device (4100). The at least one connecting device (4100) includes a female terminal (4101). The female terminal (4101) includes a female base (4110) and electrode elements (4121, 4122). The female base (4110) is made of an insulating material, and the electrode elements (4121, 4122) of the female terminal (4101) are disposed in the female base (4110) and are spaced apart by an insulating structure. The female base (4110) includes a plug-in end surface (4114) and two electrode grooves (4115). The electrode elements of the female terminal (4101) are one-to-one disposed in the electrode grooves (4115). A distance between any one of the electrode elements of the female terminal (4101) and the plug-in end surface (4114) of the female terminal (4101) is greater than 0.

### TECHNICAL FIELD

The present disclosure relates to a lamp powered by mains power.

### BACKGROUND

Lamps, such as string lights, comprise light-emitting bodies configured to emit light and wiring terminals configured to be connected to a mains supply. Each of the wiring terminals is connected to one end of a corresponding one of the light-emitting bodies. In low-voltage applications, electrode elements of the light-emitting bodies and the wiring terminals are configured to realize an electric connection of light-emitting bodies and the wiring terminals and are insulated from each other through air, leading to short circuit.

### SUMMARY

The present disclosure provides a lamp powered by mains power. In the present disclosure, electrode elements of the female terminal of at least one connecting device are spaced apart and are disposed within a corresponding insulating structure, and electrode elements of at least one light-emitting body are spaced apart and are disposed within a corresponding insulating structure, thereby realizing physical isolation and preventing a short circuit.

### BRIEF DESCRIPTION OF DRAWINGS

FIGS. 1A, 1B, 1C, 1D, 1E, 1F, 2A, 2B, 3A, 3B, 3C, 3D, 4A, 4B, and 4C are schematic diagrams of an electrical connecting terminal according to one embodiment of the present disclosure.

FIGS. 1G, 1H, and 1I are schematic diagrams of the female base of the electrical connecting terminal according to some embodiments of the present disclosure.

FIG. 2C is a schematic diagram of a first electrode element of the electrical connecting terminal according to some embodiments of the present disclosure.

FIGS. 3E and 3F are schematic diagrams of a male base of the electrical connecting terminal according to some embodiments of the present disclosure.

FIG. 4D is a schematic diagram of a second electrode element of the electrical connecting terminal according to some embodiments of the present disclosure.

FIGS. 5A, 5B, 6A, 6B, 6C, 7A, 7B, 7C, 8A, 8B, and 8C are schematic diagrams of an electrical connecting device according to some embodiments of the present disclosure.

FIGS. 9A, 9B, 9C, 9D, 9E, 9F, 9G, 9H, 9I, 9J, 9K, 9L, 10, 11, and 12 are schematic diagrams of a terminal assembly according to some embodiments of the present disclosure.

FIGS. 13 and 14 are schematic diagrams of an electrical connector according to some embodiments of the present disclosure.

FIGS. 15A, 15B, 16, 17, 18A, 18B, 18C, 18D, 19, 20, 21A, 21B, 22, 23, 24A, 24B, 24C, 24D, 25, 26, and 27 are schematic diagrams of a light-emitting body according to some embodiments of the present disclosure.

FIGS. 28A, 28B, 28C, 28D, 28E, 28F, 28G, 28H, 28I, 28J and 28K are schematic diagrams of a lamp according to some embodiments of the present disclosure.

FIGS. 29A and 29B are schematic diagrams of a lampshade of the lamps according to some embodiments of the present disclosure.

FIGS. 30A and 30B are schematic diagrams of the lamps according to some embodiments of the present disclosure.

FIG. 30C is an enlarged schematic diagram of area S1 shown in FIG. 30B.

FIGS. 31A, 31B, and 31C are schematic diagrams of the connecting devices according to some embodiments of the present disclosure.

FIGS. 32A and 32B are schematic diagrams of the lamps according to some embodiments of the present disclosure.

FIG. 32C is an enlarged schematic diagram of area S2 shown in FIG. 32B.

FIGS. 32D and 32E are partial exploded schematic diagrams of the lamp according to some embodiments of the present disclosure.

FIGS. 33A and 33B are schematic diagrams of a first connecting device according to some embodiments of the present disclosure.

FIGS. 34A and 34B are schematic diagrams of a second connecting device according to some embodiments of the present disclosure.

FIGS. 35A, 35B, 35C, 35D, and 35E are schematic diagrams of the connecting device according to some embodiments of the present disclosure.

FIG. 36A is a schematic diagram of the first connecting component and the third connecting component shown in a connected state according to some embodiments of the present disclosure.

FIG. 36B is a schematic diagram of the first connecting component and the third connecting component shown in separated state according to some embodiments of the present disclosure.

FIGS. 37-40 are schematic diagrams of the lamps according to some embodiments of the present disclosure.

### DETAILED DESCRIPTION

Reference herein to “embodiment” means that a particular feature, structure, or characteristic described in connection with one embodiment may be included in at least one embodiment of the present disclosure. The appearances of the “embodiment” in various positions in the specification are not necessarily referring to the same embodiment, and are not independent or alternative embodiments mutually exclusive of other embodiments. Those skilled in the art explicitly and implicitly understand that the embodiments described herein may be combined with other embodiments.

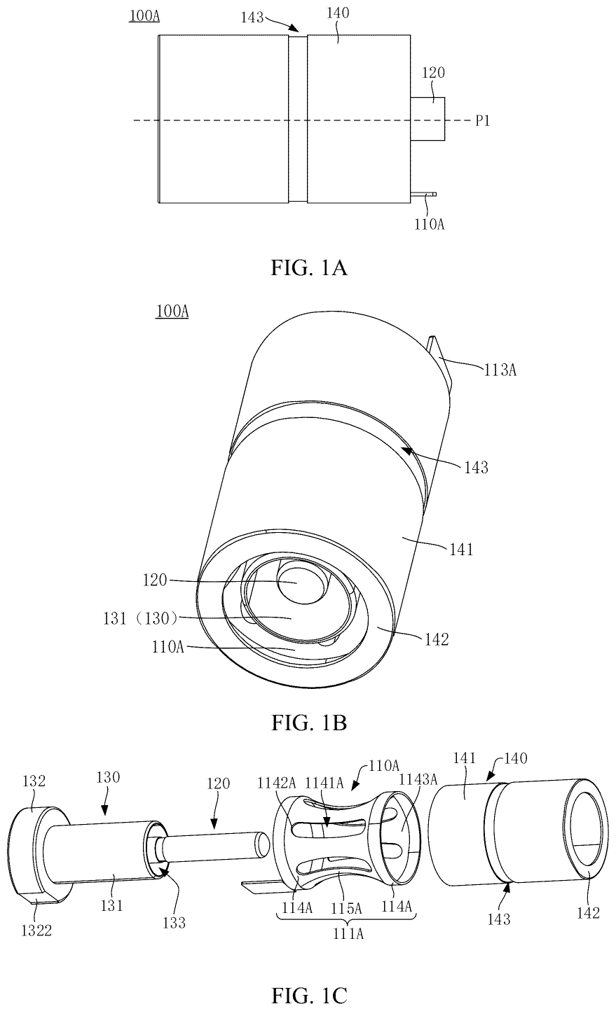

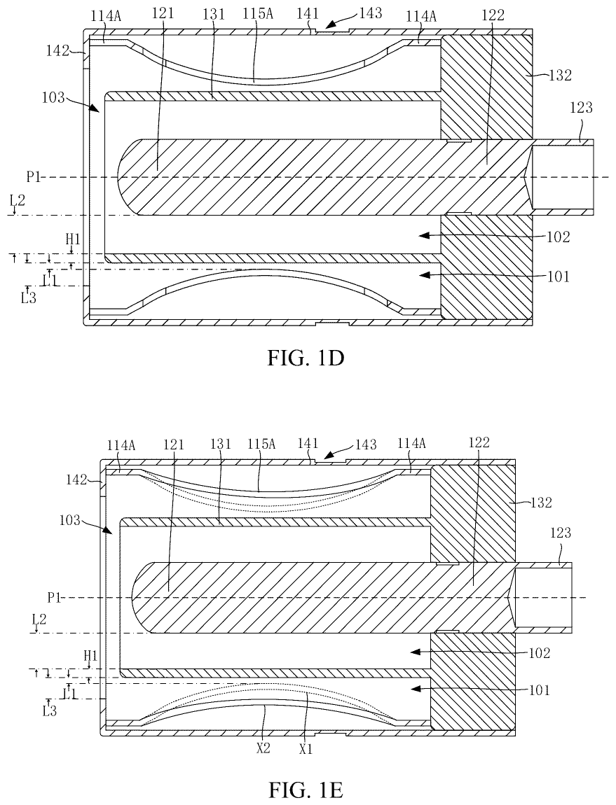

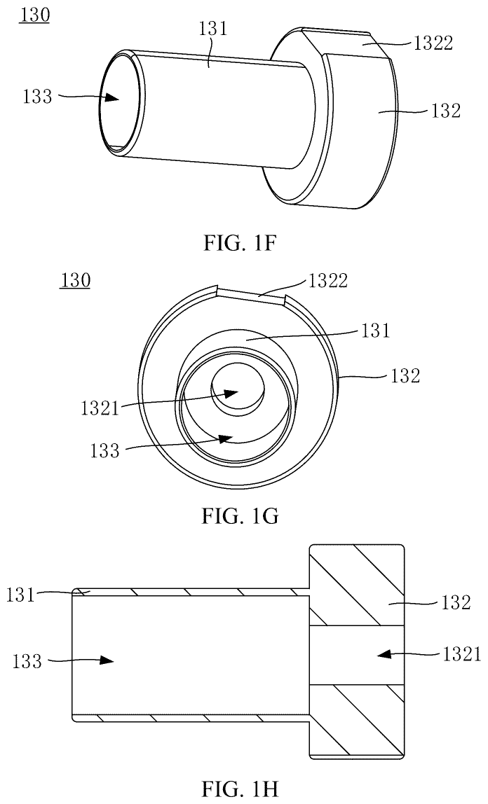

As shown in FIGS. 1A, 1B, 1C, 1D, 1E, IF, 1G, 1H, 1I, 2A, 2B, 2C, 3A, 3B, 3C, 3D, 3E, 3F, 4A, 4B, 4C, and 4D, embodiments of the present disclosure provide an electrical connecting terminal (100A, 100B, 200A, 200B) powered by mains power. The mains power is understood as alternating current (AC). An effective voltage of the AC is 100-240V, such as 100V, 110V, 120V, 220V, and 230V. The electrical connecting terminal (100A, 100B, 200A, 200B) powered by mains power is referred to as the electrical connecting terminal (100A, 100B, 200A, 200B) described below. The electrical connecting terminal (100A, 100B, 200A, 200B) is able to be applied in an electrical appliance, such as a lamp.

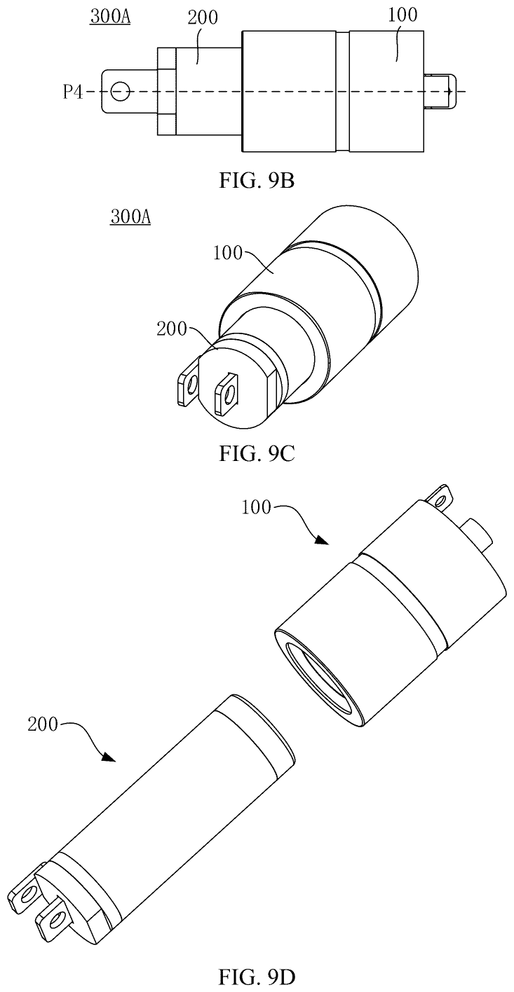

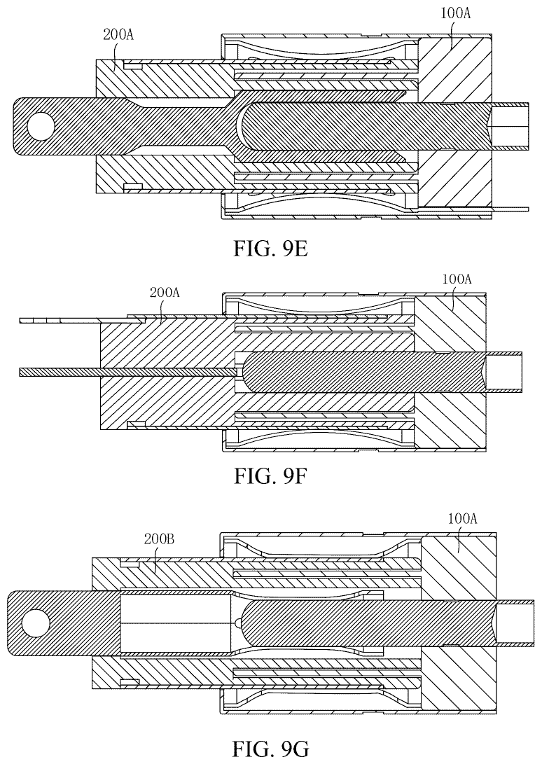

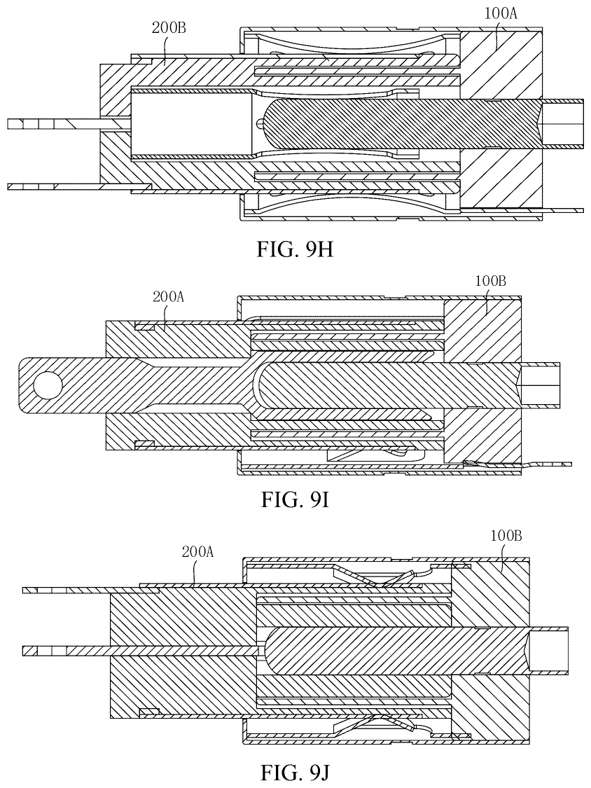

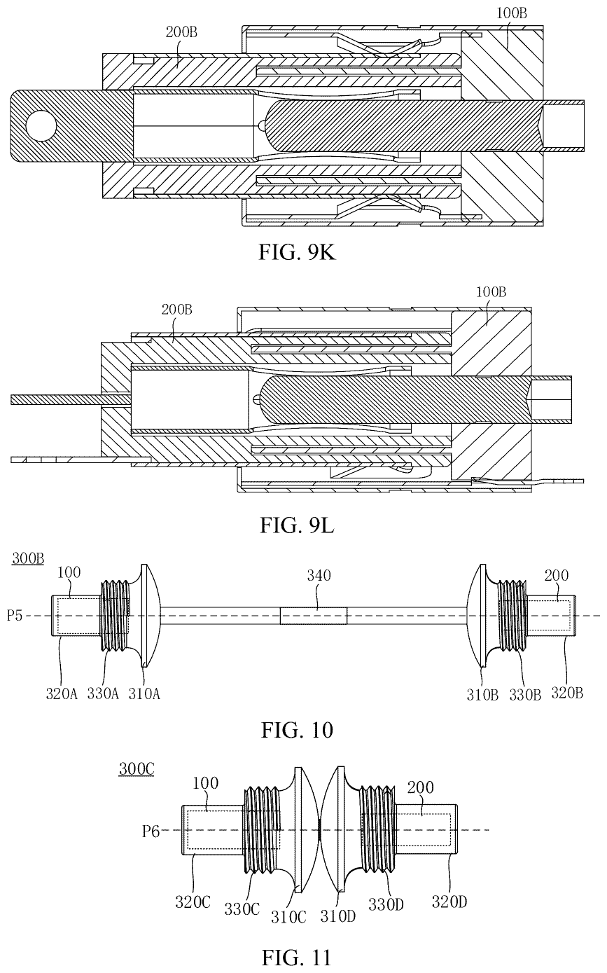

In some embodiments, the electrical connecting terminal (100A, 100B) is a female terminal (100A, 100B), or the electrical connecting terminal (200A, 200B) is a male terminal (200A, 200B). In some embodiments, as shown in FIGS. 9A-9C, the electrical connecting terminal (200A, 200B) is detachably plugged with the electrical connecting terminal (100A, 100B). In other embodiments, as shown in FIG. 10, the electrical connecting terminal (200A, 200B) and the electrical connecting terminal (100A, 100B) are connected by a wire. In other embodiments, as shown in FIG. 11, the electrical connecting terminal (200A, 200B) and the electrical connecting terminal (100A, 100B) are directly connected.

For instance, the electrical connecting terminal (100A, 100B) defines a receiving space configured to accommodate at least a portion of another terminal, such as the male terminal (200A, 200B). As shown in FIGS. 9A-9C, when at least a portion of the electrical connecting terminal (200A, 200B) is accommodated in the receiving space of the electrical connecting terminal (100A, 100B), that is, when at least a portion of the electrical connecting terminal (200A, 200B) is plugged into the electrical connecting terminal (100A, 100B), the electrical connecting terminal (200A, 200B) and the electrical connecting terminal (100A, 100B) are physically and electrically connected. FIGS. 9A-9C illustrate a physical and electrical connection state of the electrical connecting terminal (200A, 200B) and the electrical connecting terminal (100A, 100B). It should be noted that the electrical connecting terminal (200A, 200B) and the electrical connecting terminal (100A, 100B) are separable after being physically and electrically connected. As shown in FIG. 9D, FIG. 9D illustrates a separated state of the electrical connecting terminal (200A, 200B) and the electrical connecting terminal (100A, 100B). In the embodiments of the present disclosure, the electrical connecting terminal (200A, 200B) and the electrical connecting terminal (100A, 100B) are rotatable relative to each other during and after a plugging process.

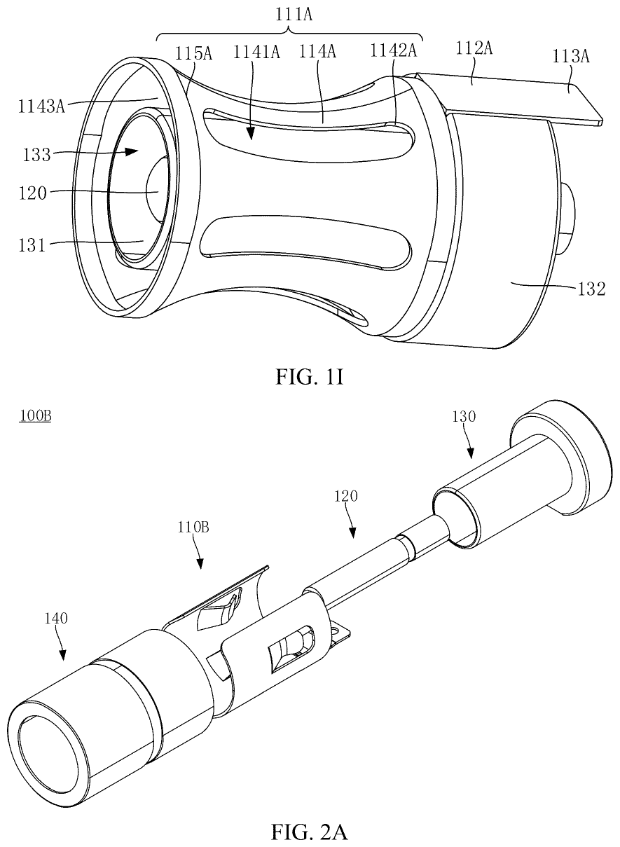

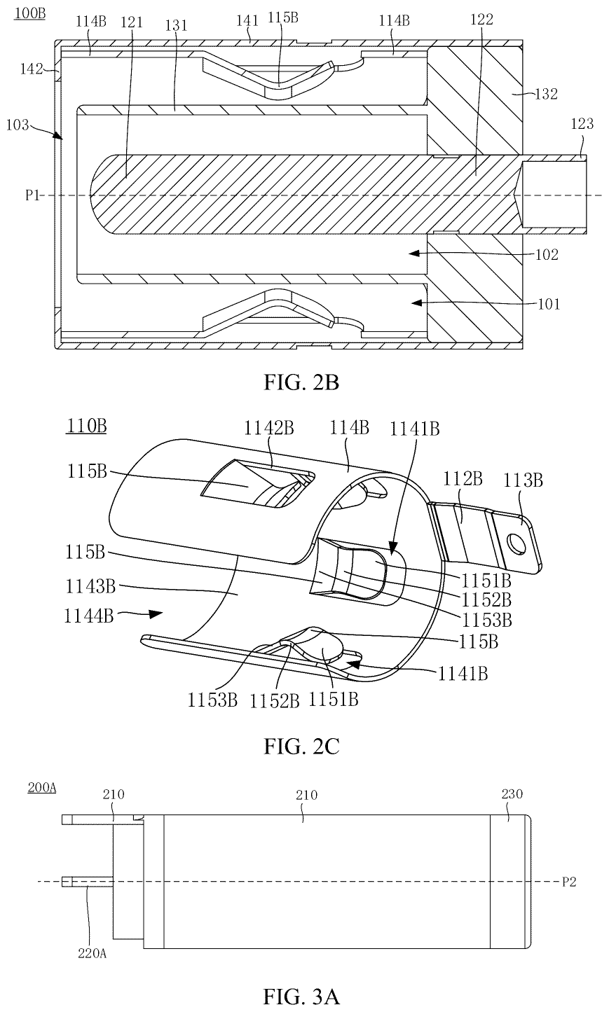

As shown in FIGS. 1A-1I, the electrical connecting terminal 100A comprises a first electrode element 110A, a second electrode element 120, and a female base 130. As shown in FIGS. 2A-2C, the electrical connecting terminal 100B comprises the first electrode element 110B, the second electrode element 120, and the female base 130. The second electrode element 120 and the female base 130 of the electrical connecting terminal 100A have the same structure as the second electrode element 120 and the female base 130 of the electrical connecting terminal 100B. In other alternative embodiments, the second electrode element 120 and female base 130 of the electrical connecting terminal 100A have different structures than the second electrode element 120 and the female base 130 of the electrical connecting terminal 100B. The electrical connecting terminal (100A, 100B) defines a first axis P1. The first electrode element 110A, the second electrode element 120, and the female base 130 of the electrical connecting terminal (100A, 100B) are rotatable together around the first axis P1.

For instance, both the first electrode element (110A, 110B) and the second electrode element 120 are made of a conductive material. When the electrical connecting terminal (100A, 100B) is energized, the first electrode element (110A, 110B) functions as a first electrode, and the second electrode element 120 functions as a second electrode. For example, the first electrode element (110A, 110B) is a negative electrode, and the second electrode element 120 is a positive electrode.

For instance, the female base 130 serves as a loading body for both the first electrode element (110A, 110B) and the second electrode element 120, and the female base 130 is made of an insulating material.

As shown in FIGS. 1C-1H, the female base 130 comprises a loading body 132 and a spacer 131 disposed at one end of the loading body 132. Specifically, the loading body 132 and the spacer 131 are integrally formed. For example, the loading body 132 and the spacer 131 are integrally formed by plastic injection molding. In other optional embodiments, the loading body 132 and the spacer 131 are fixedly connected together. For example, the loading body 132 and the spacer 131 are fixedly connected by a physical connection method, including but not limited to adhesive connection and threaded connection.

The spacer 131 and the loading body 132 jointly define a groove 133. The loading body 132 defines a through hole 1321 penetrating the loading body 132 along the first axis P1. The through hole 1321 is communicated with the groove 133, and the spacer 1321 surrounds the through hole 131, with a hole wall of the through hole 1321 spaced apart from the spacer 131. An edge of the spacer 131 is spaced apart from the loading body 132.

As shown in FIGS. 1A-1I, the first electrode element (110A, 100B) comprises a first portion (111A, 111B). The first portion (111A, 111B) of the first electrode element (110A, 100B) is disposed outside the spacer 131 and surrounds the spacer 131. An outer surface of the spacer 131 and the first electrode elements (110A, 100B) including the first portion (111A, 111B) are spaced apart to define a first spacing space 101. The first portion of the first electrode element (110A, 100B) is elastically deformable to change a size of the first spacing space 101. FIGS. 1D and 2D illustrate a state of the first portion (111A, 111B) before elastic deformation, referred to as an initial state. FIG. 1E illustrates a state of the first portion 111A after elastic deformation, referred to as a deformed state. The first portion 111A is in a second position X2 after elastic deformation from a first position X1. The first position X1 is defined as an initial position, and the second position X2 is defined as a deformation position.

As shown in FIGS. 1A-11 and 2A-2C, the second electrode element 120 comprises a first portion 121 disposed inside the spacer 131 and located in the groove 133. The spacer 131 surrounds the first portion 121 of the second electrode element 120. The spacer 131 completely limits the first portion 121 of the second electrode element 120 within the spacer 131. An inner surface of the spacer 131 is spaced apart from the first portion 121 of the second electrode element 120 to define a second spacing space 102.

The spacer 131 separates the first electrode element (110A, 100B) including the first portion (111A, 111B) from the first portion 121 of the second electrode element 120.

The female base 130, the first electrode element (110A, 110B), and the second electrode element 120 are capable of rotating together around the same axis, namely the first axis P1.

The first electrode element (110A, 110B) further comprises a second portion (112A, 112B) and a third portion (113A, 113B). The first portion (111A, 111B), the second portion (112A, 112B), and the third portion (113A, 113B) of the first electrode element (110A, 110B) are connected in sequence. The second electrode element 120 further comprises a second portion 122 and a third portion 123. The first portion 121, the second portion 122, and the third portion 123 of the second electrode element 120 are connected in sequence. The second portion (112A, 112B) of the first electrode element (110A, 110B) is disposed on the loading body 132, and the second portion 122 of the second electrode element 120 is disposed on the loading body 132, wherein the second portions (112A, 112B) of the first electrode elements (110A, 110B) and the second portion 122 of the second electrode element 120 are insulated from each other on the loading body 132. The third portion (113A, 113B) of the first electrode element (110A, 110B) is disposed outside the loading body 132, and the third portion 123 of the second electrode element 120 is disposed outside the loading body 132. The third portion (113A, 113B) of the first electrode element (110A, 110B) and the third portion 123 of the second electrode element 120 are insulated from each other.

For instance, the second portion (112A, 112B) of the first electrode element (110A, 110B) is disposed on the outer surface of the loading body 132. Specifically, the outer surface of the loading body 132 comprises at least one platform 1322, and the second portion (112A, 112B) of the first electrode element (110A, 110B) is disposed on the at least one platform 1322. Optionally, the second portion 122 of the second electrode element 120 is disposed in the through hole 1321.

For instance, the electrical connecting terminal (100A, 100B) further comprises a limiting piece 140. The limiting piece 140 comprises a first limiting body 141 and a second limiting body 142. The first limiting body 141 and the second limiting body 142 are integrally disposed. The first limiting body 141 is connected to the loading body 132 and is disposed outside the first portion (111A, 111B) of the first electrode element (110A, 110B). The first limiting body 141 is configured to limit a motion of the first portion (111A, 111B) of the first electrode element (110A, 110B) along a radial direction of the electrical connecting terminal (100A, 100B). A portion of the first limiting body 141 is disposed on an outer side of the loading body 132. The first limiting body 141 covers the second portion (112A, 112B) of the first electrode element (110A, 110B). The first limiting body 141 abuts against the second portion (112A, 112B) of the first electrode element (110A, 110B).

For instance, the second limiting body 142 is disposed at one end of the first limiting body 141 away from the loading body 132. One end of the first portion (111A, 111B) of the first electrode element (110A, 110B) away from the loading body 132 is limited in the second limiting body 142. The second limiting body 142 is configured to limit the motion of the first portion (111A, 111B) of the first electrode element (110A, 110B) in the axial direction of the electrical connecting terminal (100A, 100B). The axial direction of the electrical connecting terminal (100A, 100B) is understood as a direction of the first axis P1 of the electrical connecting terminal (100A, 100B). The second limiting body 142 is spaced apart from the spacer 131 along a radial direction of the electrical connecting terminal (100A, 100B). The limiting piece 140 in the embodiment is able to limit a motion range of the first portion (111A, 111B) of the first electrode element (110A, 110B), while the limiting piece 140 is capable of increasing a strength of the first portion (111A, 111B) of the first electrode element (110A, 110B).

In one optional embodiment, the limiting piece 140 is made of a conductive material. A portion of the first limiting body 141 is sleeved on an outer surface of the loading body 132 and connected to the loading body 132. In another optional embodiment, the limiting piece 140 is made of the insulating material, and the portion of the first limiting body 141 is connected to the outer surface of the loading body 132, or the first limiting body 141 and the spacer 131 are disposed at the same end of the loading body 132. When the limiting piece 140 is also made of the insulating material, the limiting piece 140 and the loading body 132 are integrally formed. For example, the limiting piece 140 and the loading body 132 are integrally formed by plastic injection molding. It should be noted that the limiting piece 140 and the loading body 132 may be separate components. For example, the limiting piece 140 and the loading body 132 are connected by threaded connection, adhesive layer connection, etc.

For instance, in the initial state, a distance between the first portion (111A, 111B) of the first electrode element (110A, 110B) and the spacer 131 along the radial direction of the electrical connecting terminal (100A, 100B) is a distance L1. In other words, when the first portion (111A, 111B) of the first electrode element (110A, 110B) is in the initial state, a width of the first spacing space along the radial direction of the electrical connecting terminal (100A, 100B) is L1. A width of the second spacing space 102 along the radial direction of the electrical connecting terminal (100A, 100B) is L2. A distance between the second limiting body 142 and the spacer 131 along the radial direction of the electrical connecting terminal (100A, 100B) is L3. A thickness of the spacer 131 along the radial direction of the electrical connecting terminal (100A, 100B) is H1.

$$Optionally , H 1 \geq 0.5 mm .$$

$$Optionally , L 2 \geq 1 mm .$$

$$Optionally , L 2 \geq L 1 \geq H 1.$$

Optionally, L3>L1. In this way, it ensures that another terminal, such as the male terminal (200A, 200B), is pluggable into the first spacing space 101 and the second spacing space 102 through an opening 103 of the electrical connecting terminal (100A, 100B). It should be noted that the opening 103 of the electrical connecting terminal (100A, 100B) is understood as the opening 103 of the first spacing space 101 and the opening 103 of the second spacing space 102.

For instance, the first portion 121 of the second electrode element 120 is of a cylindrical structure.

Specifically, the female base 130, the first electrode element (110A, 110B), the second electrode element 120, and the limiting piece 140 are rotatable together around the same axis, such as the first axis P1.

Specifically, the first portion 111A of the first electrode element 110A comprises abutting portions 115A and mounting portions 114A connected to the abutting portions 115A. The abutting portions 115A are capable of elastic deformation. In an initial state, the abutting portions 115A are at least partially closer to the spacer 131 than the mounting portions 114A. Similarly, the initial state of the abutting portions 115A are understood as the initial state of the first portion 111A, which is not described in detail herein.

In one optional embodiment, two ends of each of the abutting portions 115A are respectively connected to the mounting portions 114A. Optionally, the abutting portions 115A are arched.

In another alternative embodiment, a first end of each of the abutting portions 115B is connected to a corresponding one of the mounting portions 114B, while a second end of each of the abutting portions 115B is separated from the other one of the mounting portions 114B. For example, the second end of each of the abutting portions 115B is away from the opening 103 of the electrical connecting terminal 100B. For example, each of the abutting portions 115B comprises a first deformable structure 1151, a second deformable structure 1152, and a third deformable structure 1153 that are connected in sequence. For each of the abutting portions 115B, the first deformable structure 1151 thereof, the second deformable structure 1152 thereof, and the third deformable structure 1153 thereof are capable of deformation, and the first deformable structure 1151 thereof and third deformable structure 1153 thereof are bent relative to the second deformable structure 1152. The second deformable structure 1152 is closer to the spacer 131 than the first deformable structure 1151 thereof and third deformable structure 1153 thereof. During a plugging process of another terminal, such as the male terminal (200A, 200B), into the electrical connecting terminal 100B, one of the electrode elements of the male terminal (200A, 200B) first abuts against each second deformable structure 1152, and the male terminal (200A, 200B) continues to connect to the electrical connecting terminal 100B. The male terminal (200A, 200B) drives each second deformable structure 1152 to deform first, thereby driving the first deformable structure 1151 and the third deformable structure 1153 to deform, thereby changing a size of the first spacing space 101.

The first electrode element (110A, 110B) further comprise through holes (1141A, 1141B) formed on the mounting portions (114A, 114B). The through holes (1141A, 1141B) are spaced apart from each other. In one optional embodiment, each of the through holes 1141A is formed between each two adjacent abutting portions 115A. A hole wall 1142A of each of the through holes 1141A forms part of corresponding two adjacent abutting portions 115A. In another optional embodiment, two ends of each of the abutting portions 115A are directly connected to inner surfaces 1143A of the mounting portions 114A.

In one optional embodiment, positions of the abutting portions 115B are respectively corresponding to positions of the through holes 1141B. Each of the abutting portions 115B is connected to the hole wall 1142B of a corresponding one of the through holes 1141B. One end or two ends of each of the abutting portions 115B are connected to the hole wall 1142B of the corresponding one of the through holes 1141B. In another alternative embodiment, one end of each of the abutting portions 115B is connected to an inner surface 1143B of a corresponding one of the mounting portions 114B.

In one optional embodiment, the mounting portions 114A are disposed around the spacer 131. In another alternative embodiment, each of the mounting portions 114B defines an opening 1144B formed on one side thereof, which saves material of the mounting portions 114B.

In actual testing, it was found that when the first electrode element (110A, 110B) and the second electrode element 120 are not spaced apart by the spacer 131, the second electrode element 120 is directly surrounded by the first electrode element (110A, 110B). That is, the second electrode element 120 is close to an inner wall of the first electrode element (110A, 110B), with no physical isolation therebetween. That is, the second electrode element 120 and the first electrode element (110A, 110B) are insulated by air, posing a risk of the second electrode element 120 contacting the first electrode element (110A, 110B). Furthermore, because the first portion (111A, 111B) of the first electrode element (110A, 110B) is capable of elastic deformation, and the first portion (111A, 111B) recesses toward the second electrode element 120, there is a risk that the first portion (111A, 111B) may detach or loosen due to deformation, potentially leading to contact between the first electrode element (110A, 110B) and the second electrode element 120, resulting in a short circuit. Based on this, the embodiment of the present disclosure provides at least one spacer, such as the spacer 131, between the two electrode elements to separate them, thus physically isolating the two electrode elements. In this way, the contact between the two electrode elements due to deformation, loosening, or detachment is avoided, thereby avoiding short circuit. Furthermore, in the embodiment of the present disclosure, the first portion (111A, 111B) of the first electrode element (110A, 110B) is enclosed by the limiting piece 140, and the first portion 121 of the second electrode element 120 is completely disposed inside the spacer 131, which ensures that the first portion (111A, 111B) of the first electrode element (110A, 110B) and the first portion 121 of the second electrode element 120 are not exposed. A gold finger is unable to touch the first electrode element (110A, 110B) and the second electrode element 120 from the opening 103 of the electrical connecting terminal (100A, 100B), making the electrical connecting terminal (100A, 100B) applicable to AC mains power and complying with electrical safety regulations. It should be noted that when the limiting piece 140 is made of the conductive material such as metal, an insulating connector is further provided on the outside of the electrical connecting terminal (100A, 100B). A device including the insulating connector and the electrical connecting terminal (100A, 100B) is defined as an electrical connecting device, which is described exemplarily below with reference to other accompanying drawings.

As shown in FIGS. 5A-5B, 6A-6C, 7A-7C, and 8A-8C, the electrical connecting device (1000A, 1000B, 1000C, 1000D) comprises an electrical connecting terminal 100 and a connecting piece 1100. The connecting piece 1100 is made of the insulating material, such as the plastic. The connecting piece 1100 covers an outer surface of the electrical connecting terminal 100 and one end surface of the electrical connecting terminal 100, allowing one end of the electrical connecting terminal 100 to define an opening to be exposed. The electrical connecting terminal 100 is either the electrical connecting terminal 100A or the electrical connecting terminal 100B.

The connecting piece 1100 may comprise a connecting body 1110 and a sleeve 1120. The sleeve 1120 is disposed on a first end surface 1111 of the connecting body 1110. For instance, the sleeve 1120 and the first end surface 1111 of the connecting body 1110 are integrally formed. An outer thread 1114 is disposed on an outer surface 1113 of the connecting body 1110. The outer thread 1114 is configured to connect with an internal thread disposed at an opening of a lampshade. The female base 130, the first electrode element (110A, 110B) and the second electrode element 120 of the electrical connecting terminal 100 are disposed on the connecting body 1110 and protrude from the first end surface 1111 of the connecting body 1110. The sleeve 1120 is disposed around the female base 130, the first electrode element (110A, 110B) and the second electrode element 120 of the electrical connecting terminal 100. The first electrode element (110A, 110B) and the second electrode element 120 are limited by the sleeve 1120. Thus, the electrical connecting terminal 100 is partially disposed in the connecting body 1110, and one end of the electrical connecting terminal 100 is wrapped by the connecting body 1110. An outer side surface of a portion of the electrical connecting terminal 100 not disposed in the connecting body 1110 is wrapped by the sleeve 1120. Another terminal, such as the male terminal (200A, 200B), is able to be plugged into the electrical connecting terminal 100 from one end of the sleeve 1120 away from the connecting body 1110.

The electrical connecting terminal 100 and the connecting piece 1100 are rotatable together around a same axis, such as a third axis P3. That is, the female base 130, the first electrode element (110A, 110B), the second electrode element 120 and the connecting piece 1100 are rotatable together around the third axis P3. The third axis P3 and the first axis P1 are coaxial.

In actual applications, before the female terminal (100A, 100B) is plugged into the male terminal (200A, 200B), the female terminal (100A, 100B) is first electrically connected to an electrical plug. The connecting piece 1100 of the embodiment ensures that the electrical connecting terminal 100 does not contact with the first electrical connecting piece (110A, 110B) during a gold finger detection process, thus meeting requirements for a device powered by AC mains power, such as a lamp. In some cases, the male terminal (200A, 200B) does not need to be covered by a connector, such as the connecting piece 1100, which facilitates the male terminal (200A, 200B) being plugged into the female terminal (100A, 100B).

For instance, as shown in FIGS. 1A-1E and 2B, the groove 143 is defined on an outer side of the first limiting body 141. The outer side of the first limiting body 141 is surrounded and connected by the connecting body 1110. The connecting body 1110 is partially disposed in the groove 143, thereby increasing a connection strength between the first limiting body 141 and the connecting body 1110.

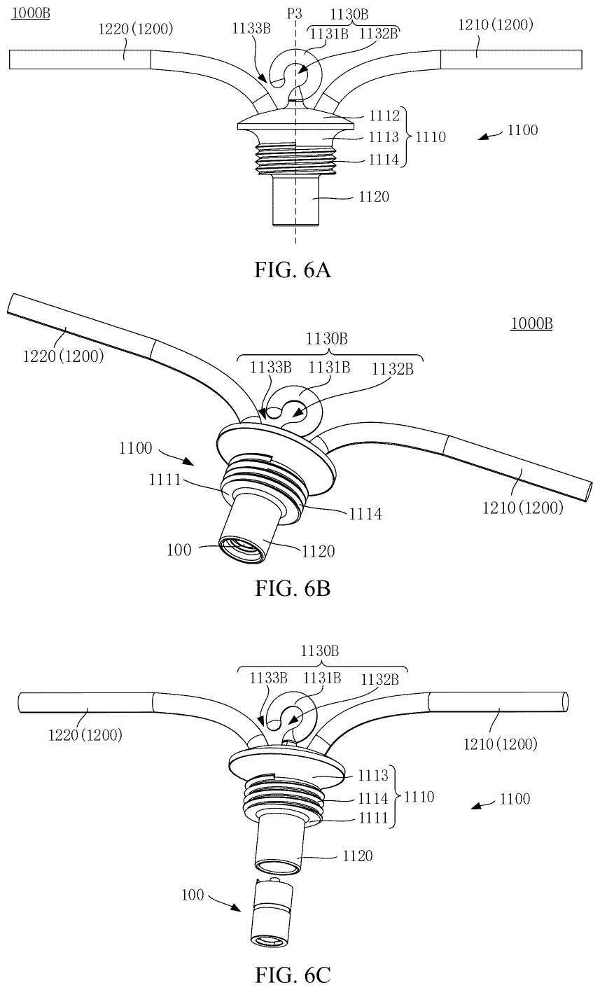

As shown in FIGS. 6A-8C, the electrical connecting device (1000B, 1000C, 1000D) further comprises a mounting body (1130B, 1130C, 1130D). The mounting body (1130B, 1130C, 1130D) is directly or indirectly connected to a second end surface 1112 of the connecting body 1110. The mounting body (1130B, 1130C, 1130D) is configured to mount the electrical connecting device (1000B, 1000C, 1000D) at a predetermined position. The predetermined position may be a wall, a ceiling, etc, which is not limited thereto.

For instance, the mounting body (1130B, 1130C, 1130D) is made of the insulating material and is integrally formed with the connecting body 1110. Optionally, the mounting body (1130B, 1130C, 1130D) is integrally formed with the connecting body 1110 by integral molding of plastic.

For instance, the mounting body (1130B, 1130C, 1130D) are connected to a center of the connecting body 1110.

In one optional embodiment, the mounting body 1130B comprises a hook 1131B, a mounting space 1132B defined by the hook 1131B, and an opening 1133B.

In another alternative embodiment, the mounting body 1130D comprises a mounting ring 1131D and a mounting space 1132D defined by the mounting ring 1131D.

In another alternative embodiment, the mounting body 1130C comprises a mounting structure 1134C, a first mounting portion 1131C, a second mounting portion 1132C, and a third mounting portion 1133C. The first mounting portion 1131C and the second mounting portion 1132C are disposed along a first direction F1. The third mounting portion 1133C and the first mounting portion 1131C and/or the second mounting portion 1132C are disposed along a second direction F2. The first direction F1 is perpendicular to the second direction F2. One end of the third mounting portion 1133C away from the first mounting portion 1131C and/or the second mounting portion 1132C is directly or indirectly connected to the second end surface 1112 of the connecting body 1110. The mounting structure 1134C is disposed along the second direction F2 with the first mounting portion 1131C and/or the second mounting portion 1132C. The mounting structure 1134C and the third mounting portion 1133C are disposed opposite to each other. The mounting structure 1134C, together with the first mounting portion 1131C and/or the second mounting portion 1132C, defines a mounting hole. Alternatively, the mounting structure 1134C, together with the first mounting portion 1131C and/or the second mounting portion 1132C, defines a mounting space and an opening. Alternatively, the mounting structure 1134C defines the mounting hole 1135C. Alternatively, the mounting structure 1134C defines the mounting space and the opening.

For instance, the mounting body 1130C comprises at least one inclined surface 1136C located on the third mounting portion 1133C, such that a size of a portion of the third mounting portion 1133C defining the at least one inclined surface 1136C is varied. For example, four inclined surfaces 1136C are provided, so that the size of the third mounting portion 1133C gradually increases from one end away from the first mounting portion 1131C and/or the second mounting portion 1132C toward one end closer to the first mounting portion 1131C and/or the second mounting portion 1132C.

Specifically, the third portion (113A, 113B) of the first electrode element (110A, 110B) and the third portion 123 of the second electrode element 120 in the electrical connecting terminal 100 are electrically connected to a first end of at least one wire 1200. For instance, the at least one wire 1200 passes through the connecting body 1110 and is electrically connected to the third portion (113A, 113B) of the first electrode element (110A, 110B) and the third portion 123 of the second electrode element 120. The at least one wire 1200 extends from the second end surface 1112 of the connecting body 1110. It is understood that the at least one wire 1200 is composed of at least two metal wires and an insulating sleeve wrapped around the metal wires. A second end of the at least one wire 1200 is electrically connected to the electrical plug. The second end surface 1112 of the connecting body 1110 is opposite to the first end surface 1111.

The at least one wire 1200 comprises one or more wires. For instance, FIGS. 5A and 5B illustrate one wire 1200.

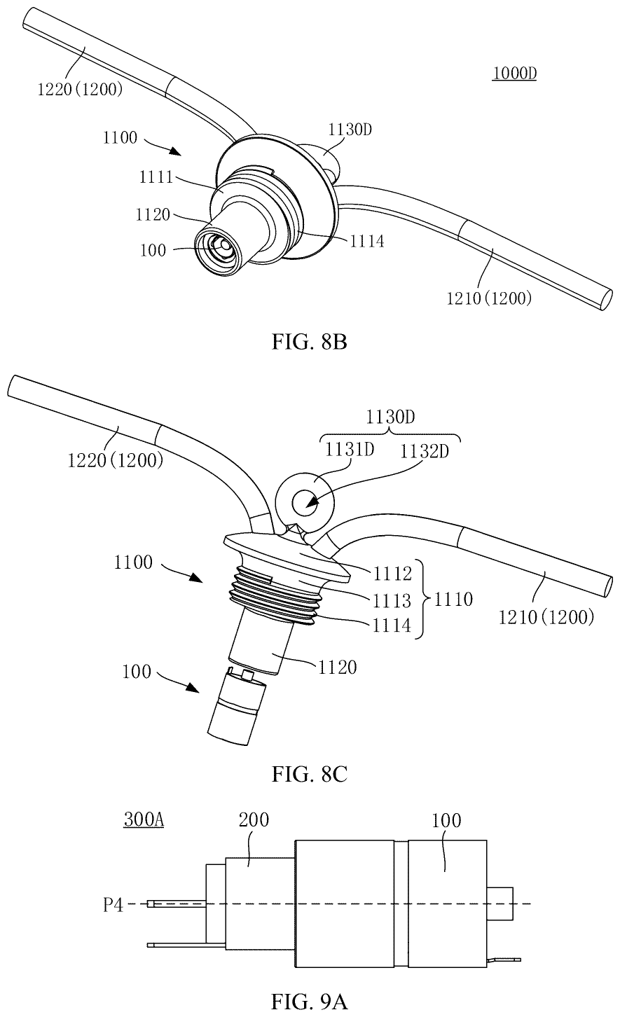

Alternatively, FIGS. 6A-6C and 8A-8C illustrate two wires 1200, which are respectively a first wire 1210 and a second wire 1220. In one case, one of the first wire 1210 and the second wire 1220 is connected to the electrical plug, and the other one of the first wire 1210 and the second wire 1220 is connected to the electrical connecting terminal of another electrical connecting device. In another case, each of the first wire 1210 and the second wire 1220 is connected to the electrical connecting terminal of a corresponding electrical connection device. Optionally, the first wire 1210 and the second wire 1220 are disposed on two opposite sides of the mounting body (1130B, 1130D).

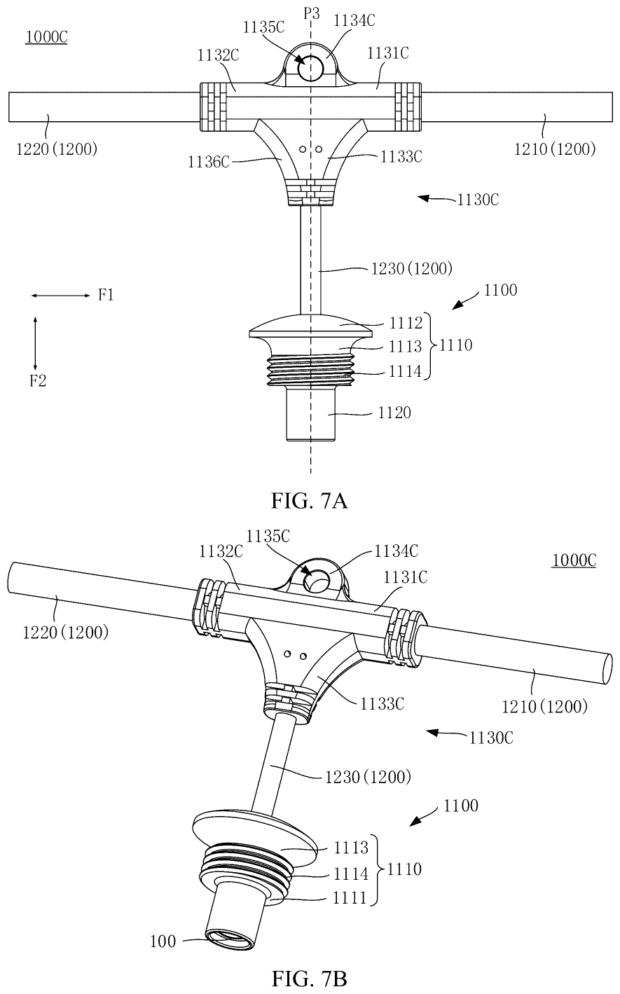

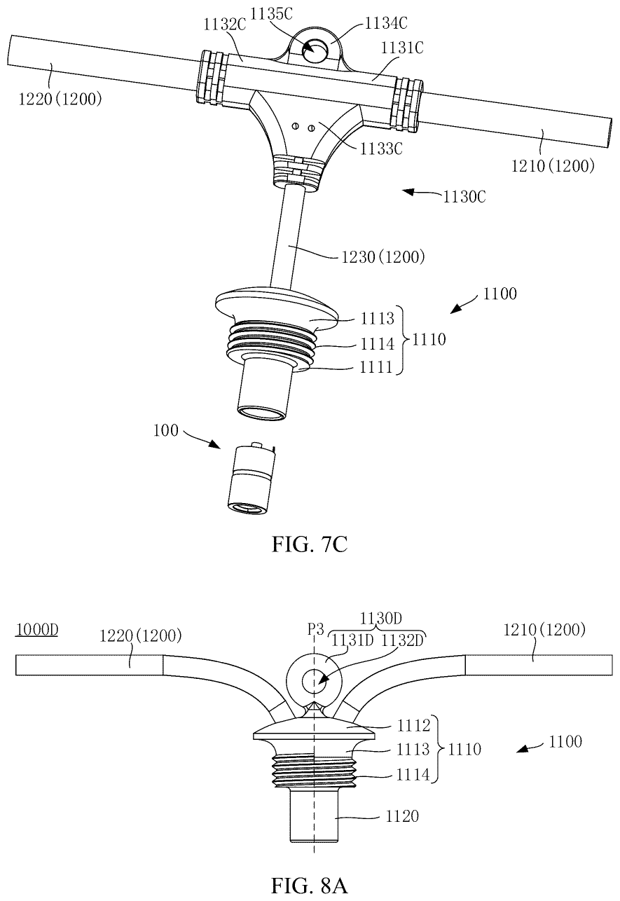

Alternatively, FIGS. 7A-7C illustrate three wires 1200, which are respectively a first wire 1210, a second wire 1220, and a third wire 1230. The third wire 1230 is directly electrically connected to the electrical connecting terminal 100, and a portion of the third wire 1230 is between the connecting body 1110 and the third mounting portion 1133C. The first wire 1210 is electrically connected to both the second wire 1220 and the third wire 1230. The second wire 1220 is electrically connected to the electrical connecting terminal of another electrical connecting device, and the first wire 1210 is electrically connected to the electrical plug. Connection joints of the first wire 1210 with the second wire 1220 and the third wire 1230 are wrapped by the mounting body 1130C. The first wire 1210 is disposed outside the first mounting portion 1131C, and the second wire 1220 is disposed outside the second mounting portion 1132C. Optionally, the third wire 1230 is disposed at the center of the connecting body 1110.

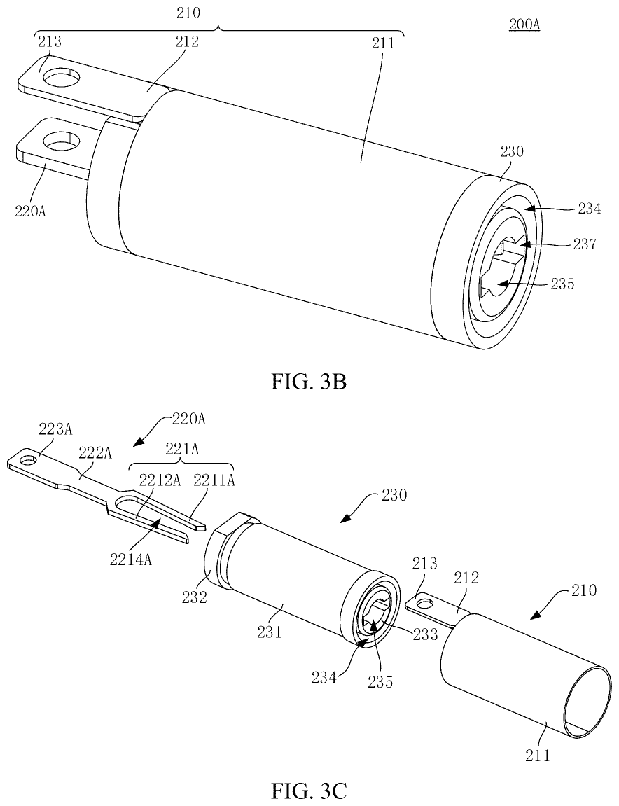

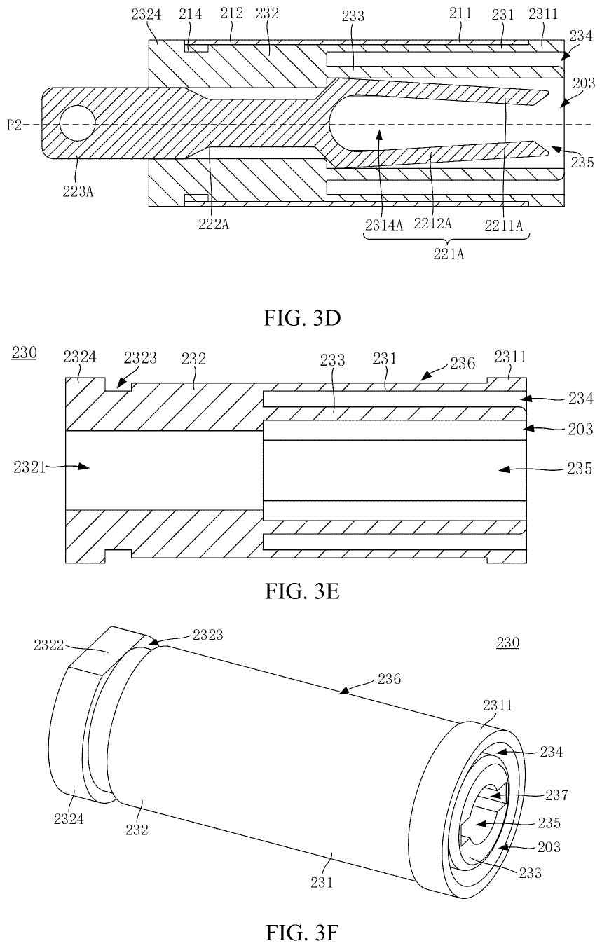

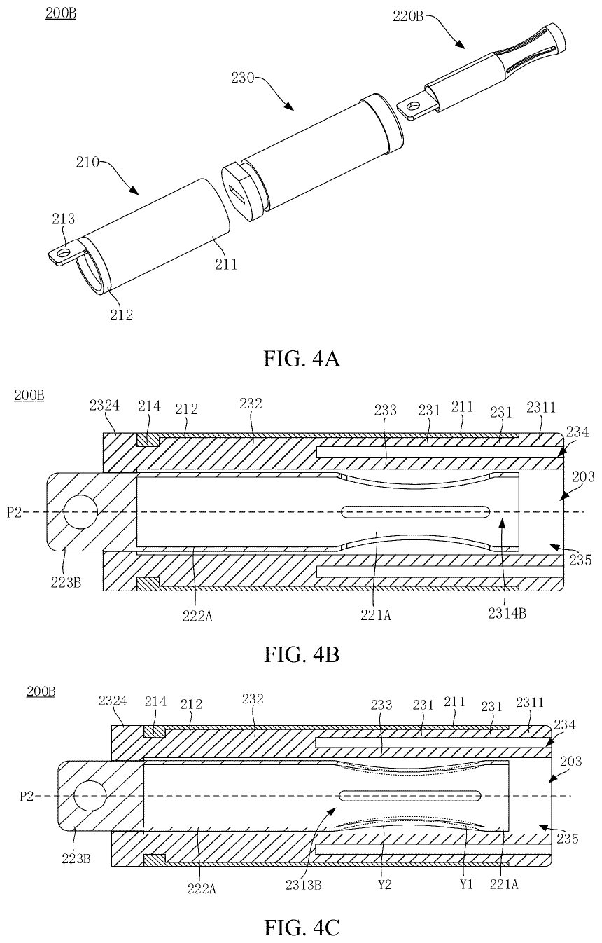

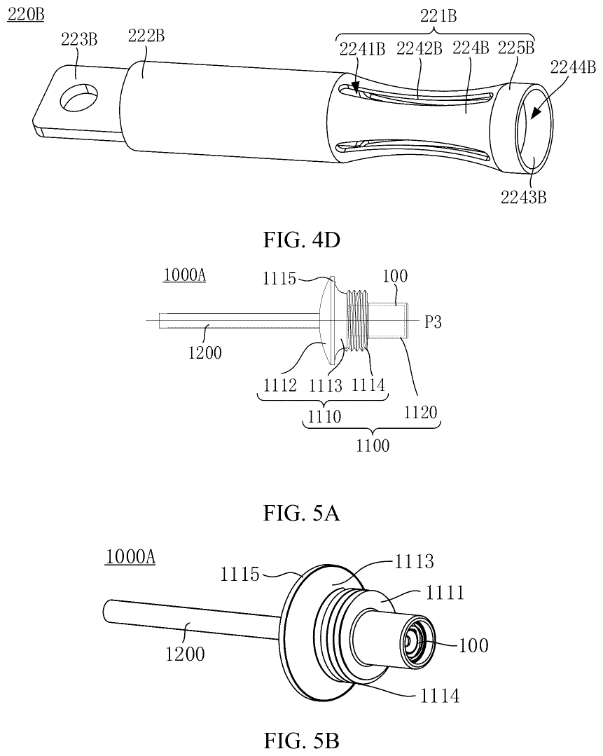

As shown in FIGS. 3A-3F, the electrical connecting terminal 200A comprises a third electrode element 210, a fourth electrode element 220A, and the male base 230. As shown in FIGS. 4A-4D, the electrical connecting terminal 200B comprises the third electrode 210, the fourth electrode 220B, and the male base 230. The third electrode element 210 and the male base 230 of the electrical connecting terminal 200A have the same structure as the third electrode element 210 and the male base 230 of the electrical connecting terminal 200B. In other optional embodiments, the third electrode element 210 and the male base 230 of the electrical connecting terminal 200A have different structures than the third electrode element 210 and the male base 230 of the electrical connecting terminal 200B. The electrical connecting terminals (200A, 200B) define a second axis P2. The third electrode element 210, the fourth electrode element (220A, 220B) and the male base 230 of the electrical connecting terminals (200A, 200B) are able to rotate together around the second axis P2.

Specifically, the third electrode element 210 and the fourth electrode element (220A, 220B) are made of the conductive material. When the electrical connecting terminal (200A, 200B) is energized, the third electrode element 210 functions as a first electrode, and the fourth electrode element (220A, 220B) functions as the second electrode; Optionally, the third electrode element 210 functions as the negative electrode, and the fourth electrode (220A, 220B) functions as the positive electrode.

Specifically, the male base 230 is configured as a carrier for the third electrode element 210 and the fourth electrode element (220A, 220B), and the male base 230 is made of the insulating material.

As shown in FIGS. 3C-3F, and 4A-4C, the male base 230 comprises an outer spacer 231 and an inner spacer 233. The outer spacer 231 surrounds the inner spacer 233. The outer spacer 231 and inner spacer 233 are spaced apart to define a first groove 234. The male base 230 further comprises a loading body 232. The outer spacer 231 and inner spacer 233 are disposed on a same end of the loading body 232. For example, the loading body 232, the outer spacer 231, and the inner spacer 233 are integrally formed, such as by injection molding of plastic. It should be noted that the first groove 234 is defined by the loading body 232, the outer spacer 231, and the inner spacer 233. The inner spacer 233 and the loading body 232 jointly define a second groove 235. When the male terminal (200A, 200B) is connected to the female terminal (100A, 100B), the third electrode element 210 of the male terminal (200A, 200B) is plugged into the first spacing space 101, the fourth electrode element (220A, 220B) is plugged into the second spacing space 102, the spacer 131 of the female terminal (100A, 100B) is plugged into the first groove 234, and the second electrode element 120 of the female terminal (100A, 100B) is plugged into the second groove 235. Optionally, a size of the first groove 234 is matched with the spacer 131.

As shown in FIGS. 3A-3D and 4B-4D, the third electrode element 210 comprises a first portion 211 disposed on the outer spacer 131. The first portion 211 is connected to the outer spacer 131. The third electrode element 210 further comprises a second portion 212 and a third portion 213. The second portion 212 is disposed on the loading body 232 and is connected to the loading body 232, while the third portion 213 is disposed outside the loading body 232. The first portion 211, the second portion 212, and the third portion 213 are connected in sequence. Optionally, the first portion 211, the second portion 212, and the third portion 213 are integrally molded.

As shown in FIGS. 3A-3F and 4A-4D, the male base (200A, 200B) further comprises a third groove 236. The third groove 236 is disposed on the outer side of the loading body 232 and the outer side of the outer spacer 231. The male bases (200A, 200B) further comprise a first limiting structure 2311 and a second limiting structure 2324. The first limiting structure 2311 is disposed on the outer side of one end of the outer spacer 231 away from the loading body 232. The second limiting structure 2324 is disposed on the outer side of one end of the loading body 232 away from the outer spacer 231. The third groove 236 is disposed between the first limiting structure 2311 and the second limiting structure 2324. The first portion 211 and a portion of the second portion 212 of the third electrode element 210 are disposed in the third groove 236, and two ends thereof are limited by the first limiting structure 2311 and the second limiting structure 2324.

In one optional embodiment, an outer surface of a portion of the third electrode element 210 disposed in the third groove 236 is flush with an outer surface of the first limiting structure 2311 and an outer surface of the second limiting structure 2324. In other optional embodiments, the outer surface of the portion of the third electrode element 210 disposed in the third groove 236 may be concave or convex compared to the outer surface of the first limiting structure 2311 and the outer surface of the second limiting structure 2324.

Optionally, the male bases (200A, 200B) further comprise a fourth groove 2323 defined on the outer side of the loading body 232. The fourth groove 2323 is close to the second limiting structure 2324. The fourth groove 2323 is communicated with the third groove 236. The third electrode element 210 further comprises a protrusion 214 disposed on an inner side of the second portion 212 of the third electrode element 210. The protrusion 214 is disposed in the fourth groove 2323 and is connected to a groove wall of the fourth groove 2323 to increase connection stability of the third electrode element 210, the loading body 232 and the outer spacer 231.

Optionally, the outer side of the loading body 232 defines at least one platform 2322, and a portion of the second portion 212 of the third electrode element 210 is disposed on the platform 2322.

Optionally, the fourth electrode element (220A, 220B) comprises a first portion (221A, 221B) disposed in the inner spacer 233. The fourth electrode element (220A, 220B) defines a plugging space (2214A, 2214B) configured to accommodate the second electrode element 120 of the female terminal (100A, 100B). The first portion (221A, 221B) of the fourth electrode element (220A, 220B) is capable of elastic deformation within the inner spacer 233 to change a size of the plugging space (2214A, 2214B). FIGS. 3D and 4B illustrate a state of the first portion (221A, 221B) of the fourth electrode element (220A, 220B) before elastic deformation, referred to as an initial state. FIG. 4C illustrates a state of the first portion 221B of the fourth electrode element (220A, 220B) after elastic deformation, referred to as a deformation state. The first portion 211B of the fourth electrode element (220A, 220B) is in a second position Y2 after elastic deformation from a first position Y1. The first position Y1 is understood as an initial position, and the second position Y2 is understood as a deformation position.

For example, the fourth electrode element (220A, 220B) further comprises a second portion (222A, 222B) and a third portion (223A, 223B). The first portion (221A, 221B), the second portion (222A, 222B) and the third portion (223A, 223B) of the fourth electrode (220A, 220B) are connected in sequence. The second portion (222A, 222B) of the fourth electrode element (220A, 220B) is disposed inside the loading body 232. The third portion (223A, 223B) of the fourth electrode element (220A, 220B) is disposed outside the loading body 232. For example, the loading body 232 comprises a through hole 2321 penetrating the loading body 232 along the second axis P2. The through hole 2321 is communicated with the second groove 235. The through hole 2321 is surrounded by the inner spacer 233. A hole wall of the through hole 2321 is spaced apart from or connected to the inner spacer 233.

For instance, the first portion 211A of the fourth electrode element 220A comprises electrode sheets, such as a first electrode sheet 2211A and a second electrode sheet 2212A. The first electrode sheet 2211A and the second electrode sheet 2212A are spaced apart by the plugging space 2214A. Optionally, the first electrode sheet 2211A and the second electrode sheet 2212A are disposed opposite to each other. A distance between the first electrode sheet 2211A and the second electrode sheet 2212A is variable. For example, the distance between the first electrode sheet 2211A and the second electrode sheet 2212A gradually increases and then gradually decreases from a first end of the opening 203 of the electrical connecting terminal 200A towards a second end, to facilitate an insertion of the second electrode element 120 of another electrical connecting terminal, such as the female terminal (100A, 100B), into the plugging space 2214.

In the embodiment, the inner spacer 233 further comprises fifth grooves 237. The fifth grooves 237 are communicated with the second groove 235. The number of the fifth grooves 237 is the same as the number of the electrode sheets (2211A, 2212A). For instance, there are two fifth grooves 237, and the electrode sheets (2211A, 2212A) are one-to-one accommodated in the fifth grooves 237. The first electrode sheet 2211A and the second electrode sheet 2212A are capable of elastic deformation in the second groove 235 and the fifth grooves 237. Specifically, during a mutual plugging process of the female terminal (100A, 100B) and the male terminal (200A, 200B), the second electrode element 120 is plugged into the plugging space 2214A, thereby driving the electrode sheets (2211A, 2212A) to elastically deform. The opening 203 is understood as an opening of the first groove 234 and an opening of the second groove 235.

For instance, the first portion 211B of the fourth electrode element 220B comprises a mounting portion 225B and abutting portions 224B. The abutting portions 224B are capable of elastic deformation. In an initial state, at least a portion of each of the abutting portions 224B is spaced apart from an inner surface of the inner spacer 233. Similarly, the initial state of the abutting portions 224B is understood as the initial state of the first portion 221B, which is not described in detail herein.

In one optional embodiment, all abutting portions 224B are connected to the mounting portions 225B. For example, the abutting portions 224B are arched. In another optional embodiment, a first end of each of the abutting portions 224B is connected to the mounting portion 225B, while a second end of each of the abutting portions 224B is separately disposed from the mounting portion 225B. Specific structures may be referred to FIGS. 2A, 2B, and 2C, which are not described in detail herein.

Specifically, the fourth electrode element 220B further comprises through holes 2241B. The through holes 2241B are spaced apart from each other. In one optional embodiment, each of the through holes 2241B is formed between each two adjacent abutting portions 224B. The hole wall 2242B forming each of the through holes 2241B is portions of the two adjacent abutting portions 224B. In another optional embodiment, each of the abutting portions 224B are directly connected to the inner surface 2243B of the mounting portion 224B. The specific structure may be referred to FIGS. 2A-2C, and is not described in detail herein.

The male base 230, the third electrode element 210, and the fourth electrode element (220A, 220B) are rotatable around the same axis, such as the second axis P2.

In the embodiment, the inner spacer 233 and the outer spacer 231 completely separate the first portion 211 of the third electrode element 210 and the first portion (221A, 221B) of the fourth electrode element (220A, 220B). Furthermore, the first groove 234 formed between the inner spacer 233 and the outer spacer 231 is able to accommodate the spacer of the female terminal (100A, 100B). Therefore, after the male terminal (200A, 200B) and the female terminal (100A, 100B) are plugged into each other, the first electrode element (110A, 110B) and the third electrode element 210 are electrically connected, and the second electrode element 120 and the fourth electrode element (220A, 220B) are electrically connected. Moreover, the first electrode element (110A, 110B) and the third electrode element 210 are at least separated from the second electrode element 120 and the fourth electrode element (220A, 220B) by the spacer 131, the inner spacer 233 and the outer spacer 231, thereby ensuring that there is sufficient physical isolation between the electrode elements after the male terminal (200A, 200B) and the female terminal (100A, 100B) are plugged with each other. In this way, safety performance is ensured.

As shown in FIGS. 9A-9L and 10,-12, embodiments of the present disclosure provide a terminal assembly (300A, 300B, 300C, 300D) powered by mains power. The terminal assembly (300A, 300B, 300C, 300D) powered by mains power is referred to as the terminal assembly (300A, 300B, 300C, 300D) described below. The terminal assembly (300A, 300B, 300C, 300D) is able to be applied to an electrical appliance, such as a lamp. The terminal assembly (300A, 300B, 300C, 300D) comprises a female terminal 100 and a male terminal 200. The female terminal 100 refers to either the female terminal 100A or the female terminal 100B as described above, and the male terminal 200 refers to either the male terminal 200A or the male terminal 200B as described above. For instance, the terminal assembly illustrated in FIGS. 9E and 9F comprises the female terminal 100A and the male terminal 200A. The terminal assembly illustrated in FIGS. 9G and 9H comprises the female terminal 100A and the male terminal 200B. The terminal assembly illustrated in FIGS. 91 and 9J comprises the female terminal 100B and the male terminal 200A. The terminal assembly illustrated in FIGS. 9K and 9 comprises the female terminal 100B and the male terminal 200B. The specific structures of the female terminal 100 and the male terminal 200 are not described in detail in the embodiment.

In some embodiments, as shown in FIGS. 9A-9L, the male terminal 200 and female terminal 100 of the terminal assembly 300A are able to be plugged with each other and separated from each other. FIGS. 9A-9C and 9E-9L illustrate a plugged-in state of the male terminal 200 and female terminal 100, while FIG. 9D illustrates a separated state of the male terminal 200 and female terminal 100.

After the male terminal 200 and the female terminal 100 are plugged with each other, the first portion 211 of the third electrode element 210 and the outer spacer 231 are disposed in the first spacing space 101, and the first portion 211 of the third electrode element 210 contacts the abutting portions (115A, 115B) of the first electrode element (100A, 100B). The first portion (221A, 221B) of the fourth electrode element (220A, 220B) and the inner spacer 233 are disposed in the second spacing space 102. The first portion 121 of the second electrode element 120 is disposed in the plugging space (2214A, 2214B) of the fourth electrode element (220A, 220B), and the first portion 121 of the second electrode element 120 contacts the first portion (221A, 221B) of the fourth electrode element (220A, 220B), thereby realizing an electrical connection between the male terminal 200 and the female terminal 100.

During or after the plugging process of the male terminal 200 and the female terminal 100, the male terminal 200 and the female terminal 100 are rotatable relative to each other. For example, the male terminal 200 and the female terminal 100 care rotatable around the fourth axis P4. Furthermore, the first portion 211 of the third electrode element 210 is spaced apart from the first portion (110A, 110B) of the first electrode element (100A, 100B) by at least the inner spacer 233, the outer spacer 231, and the spacer 131 of the female base 130, and the first portion 121 of the second electrode element 120 is spaced apart from the first portion (221A, 221B) of the fourth electrode element (220A, 220B) by at least the inner spacer 233, the outer spacer 231, and the spacer 131 of the female base 130.

During or after the plugging process of the male terminal 200 and female terminal 100, the first portion 211 of the third electrode element 210 presses the first portion (110A, 110B) of the first electrode element (100A, 100B) to cause the elastic deformation of the first portion (110A, 110B) of the first electrode element (100A, 100B), thereby ensuring that the first portion 211 of the third electrode element 210 and the first portion (110A, 110B) of the first electrode element (100A, 100B) are in close contact. Meanwhile, the first portion 121 of the second electrode element 120 presses the first portion (221A, 221B) of the fourth electrode element (220A, 220B) to cause the elastic deformation of the first portion (221A, 221B) of the fourth electrode element (220A, 220B), thereby ensuring that the first portion 121 of the second electrode element 120 and the first portion (221A, 221B) of the fourth electrode element (220A, 220B) are in close contact.

Optionally, the outer surface of each of the electrode elements of the female terminal 100 is discontinuous, while the outer surface of each of the electrode elements of the male terminal 200 is continuous. For instance, the outer surface of each of the electrode elements of the male terminal 200 is smoothly transitioned. It should be noted that the female terminal 100 is electrically connected to the electrical plug before the male terminal. To ensure electrical safety of a user, a connecting piece 1100 made of the insulating material is disposed on the outer side of the female terminal 100. The outer surface of each of the electrode elements of the female terminal 100, such as the first electrode element (110A, 110B), is discontinuous, which facilitates connection with the connecting piece 1100.

In other embodiments, as shown in FIG. 10, the male terminal 200 and female terminal 100 of the terminal assembly 300B are connected by a wire 340. The wire 340 spaces the male terminal 200 and female terminal 100 apart. The male terminal 200, the female terminal 100, and the wire 340 are rotatable together around a fifth axis P5. The terminal assembly 300B further comprises a first connecting body 310A, a second terminal body 310B, a first outer thread 330A, a second outer thread 330B, a first sleeve 320A, and a second sleeve 320B. The female terminal 100 is disposed inside the first sleeve 320A and the first connecting body 310A. The first outer thread 330A is disposed on an outer surface of the first connecting body 310A. The male terminal 200 is disposed inside the second sleeve 320B and the second connecting body 310B. The second outer thread 330B is disposed on an outer surface of the second connecting body 310B. The male terminal 200 shown in FIG. 10 is configured to connect with another female terminal, and the female terminal shown in FIG. 10 is configured to connect with another male terminal. It should be noted that there is a space between the second sleeve 320B and the male terminal 200. The second sleeve 320B is able to be sleeved on another female terminal during the connection process of the male terminal 200 with another female terminal.

In other embodiments, as shown in FIG. 11, the male terminal 200 and the female terminal 100 of the terminal assembly 300C are directly connected. The male terminal 200 and the female terminal 100 are rotatable together around a sixth axis P6. The terminal assembly 300C further comprises a first connecting body 310C, a second terminal body 310D, a first outer thread 330C, a second outer thread 330D, a first sleeve 320C, and a second sleeve 320D. The female terminal 100 is disposed in the first sleeve 320C and the first connecting body 310C. The first outer thread 330C is disposed on an outer surface of the first connecting body 310C. The male terminal 200 is disposed in the second sleeve 320D and the second connecting body 310D. The second outer thread 330D is disposed on an outer surface of the second connecting body 310D. The male terminal 200 shown in FIG. 11 is configured to connect with another female terminal, and the female terminal shown in FIG. 11 is configured to connect with another male terminal. It should be noted that there is a space between the second sleeve 320D and the male terminal 200. The second sleeve 320D is able to be sleeved on another female terminal during the connection process of the male terminal 200 with another female terminal.

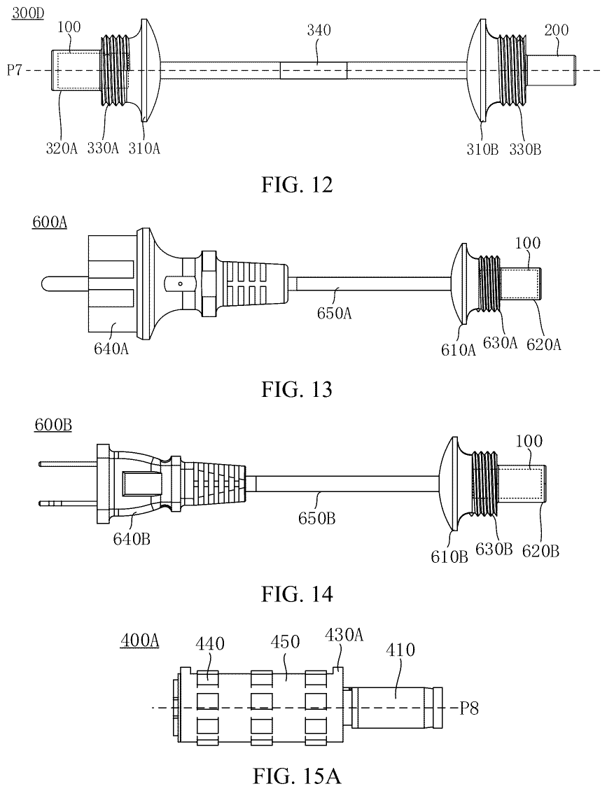

In other embodiments, as shown in FIG. 12, the terminal assembly 300D shown in FIG. 12 differs from the terminal assembly 300B shown in FIG. 10 in that the male terminal 200 is directly connected to the second connecting body 310B, and an outer side of the male terminal 200 is not covered by the second sleeve. Similarly, the male terminal 200 and the female terminal 100 shown in FIG. 12 are rotatable together around a seventh axis P7.

As shown in FIGS. 13 and 14, the embodiment of the present disclosure provides an electrical connector (600A, 600B). The electrical connector (600A, 600B) comprises an electrical plug (640A, 640B), a wire (650A, 650B), and a female terminal 100. The female terminal 100 may refer to either the female terminal 100A or the female terminal 100B, and is not described in detail herein. The electrical plug 640A is physically and electrically connected to the female terminal 100 through the wire 650A. The electrical plug 640B is physically and electrically connected to the female terminal 100 through the wire 650B. A structure of the electrical plug 640A is different from a structure of the electrical plug 640B. Specifically, pins of the electrical plug 640A are roughly cylindrical, while pins of the electrical plug 640B are roughly cuboid. Optionally, the electrical connector (600A, 600B) further comprises a connecting body (610A, 610B), a sleeve (620A, 620B), and an outer thread (630A, 630B). A female terminal 100 is disposed in the connecting body (610A, 610B) and the sleeve (620A, 620B), and the outer thread (630A, 630B) is disposed on an outer surface of the connecting body (610A, 610B). The connecting body (610A, 610B), the sleeve (620A, 620B), and the outer thread (630A, 630B) may be referenced from the above description and are not repeated herein.

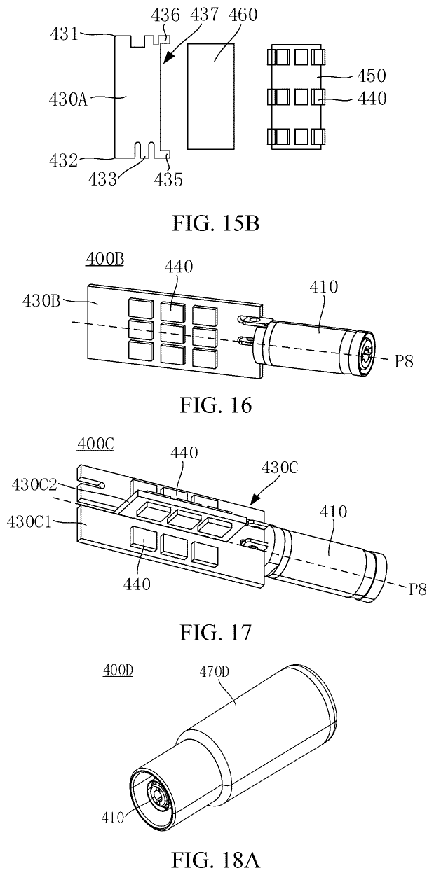

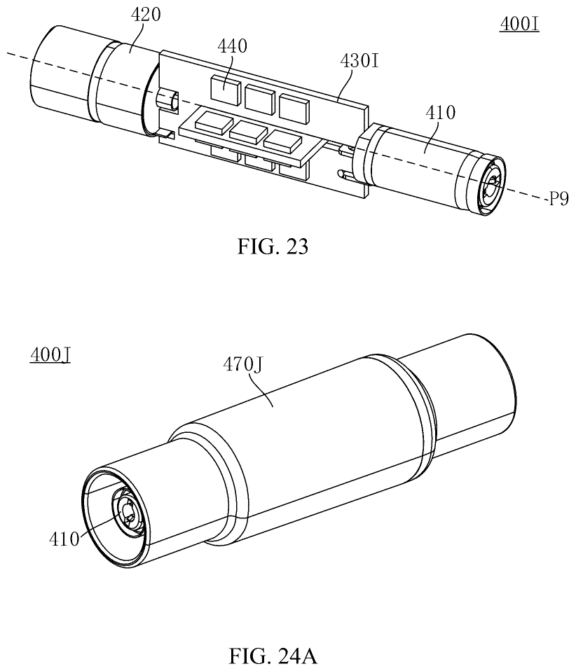

As shown in FIGS. 15A-27, the present disclosure further provides a light-emitting body (400A, 400B, 400C, 400D, 400E, 400F, 400G, 400H, 400I, 400J, 400K, 400L, 400M, abbreviated as 400A-M) configured to be under mains power. The light-emitting body (400A-M) configured to be used under the mains power is referred to as light-emitting body (400A-M) below. The light-emitting body (400A-M) is applied to a light-emitting electrical appliance, such as a lamp.

In one optional embodiment, as shown in FIGS. 15A-20 and 27, the light-emitting body (400A, 400B, 400C, 400D, 400E, 400F, 400M) comprises one or more light-emitting elements 440, a male terminal 410, and a rigid circuit board (430A, 430B, 430C, 430D, 430E, 430F, 430M). The rigid circuit board (430A, 430B, 430C, 430M) is electrically connected to the one or more light-emitting elements 440 to control the one or more light-emitting elements 440 to emit light. The one or more light-emitting elements 440 are LED light-emitting elements. The male terminal 410 is fixed to the rigid circuit board (430A, 430B, 430C, 430M) and is electrically connected to the rigid circuit board (430A, 430B, 430C, 430M). The male terminal 410 may refer to the male terminal 200A or the male terminal 200B described above, and a specific structure of the male terminal 410 is not described in detail herein. After the male terminal 410 is fixedly connected to the rigid circuit board (430A, 430B, 430C, 430M), the male terminal 410 and the rigid circuit board (430A, 430B, 430C, 430M) are rotatable together around an eighth axis P8. The male terminal 410 is able to be plugged into any of above female terminals, such as the female terminal 100A or the female terminal 100B.

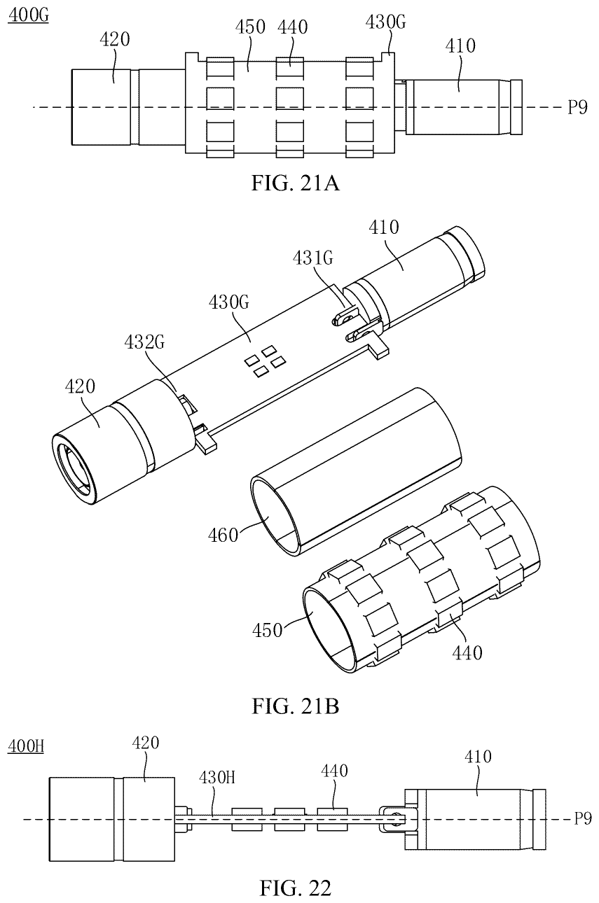

In another optional embodiment, as shown in FIGS. 21A-26, the light-emitting body (400G, 400H, 400I, 400J, 400K, 400L) comprises one or more light-emitting elements 440, a male terminal 410, a female terminal 420, and a rigid circuit board (430G, 430H, 430I, 430J, 430K, 430L). The rigid circuit board (430G, 430H, 430I, 430J, 430K, 430L) is electrically connected to the one or more light-emitting elements 440 to control the one or more light-emitting elements 440 to emit light. The one or more light-emitting elements 440 are LED light-emitting elements. The male terminal 410 and the female terminal are rigidly fixed to the rigid circuit board (430G, 430H, 430I, 430J, 430K, 430L). The male terminal 410 and the female terminal are electrically connected to the rigid circuit board (430G, 430H, 430I, 430J, 430K, 430L). The male terminal 410 may refer to the male terminal 200A or the male terminal 200B described above. The female terminal 100 may refer to the female terminal 100A or the female terminal 100B described above. The specific structures of the male terminal 410 and the female terminal 420 are not described in detail herein. After the male terminal 410 and female terminal 420 are fixedly connected to the rigid circuit boards (430G, 430H, 430I, 430J, 430K, 430L), the male terminal 410, the female terminal 420, and the rigid circuit boards (430G, 430H, 430I, 430J, 430K, 430L) are rotatable together around a ninth axis P9. The male terminal 410 is able to be plugged into another female terminal, such as the female terminal 100A or the female terminal 100B. The female terminal 420 is able to be plugged into another male terminal, such as the male terminal 200A or the male terminal 200B.

Optionally, the male terminal 410 is disposed at a first end of the rigid circuit board (430G, 430H, 430I, 430J, 430K, 430L), and the female terminal 420 is disposed on a second end of the rigid circuit board (430G, 430H, 430I, 430J, 430K, 430L). Namely, the male terminal 410 and the female terminal 420 are disposed opposite to each other. It should be noted that a positional relationship of the male terminal 410, the female terminal 420, and the rigid circuit board (430G, 430H, 430I, 430J, 430K, 430L) is not limited thereto. In other optional embodiments, the male terminal 410 and the female terminal 420 form an angle greater than 0 degrees and less than 180 degrees with respect to the rigid circuit board (430G, 430H, 430I, 430J, 430K, 430L).

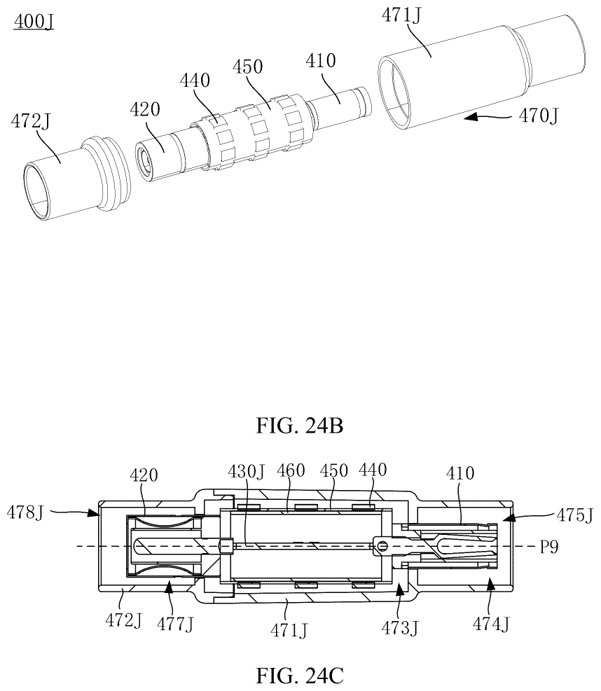

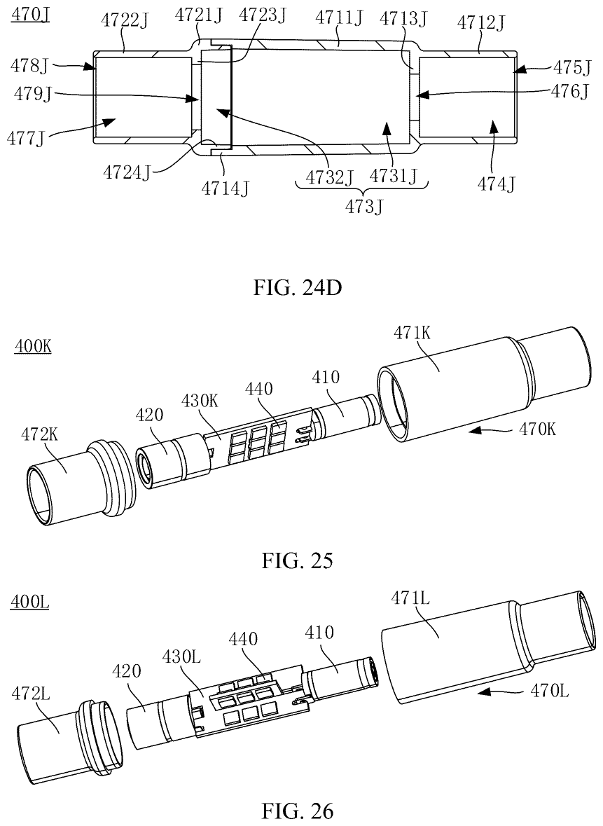

As shown in FIGS. 24A-26, to ensure the safety performance of the light-emitting body (400J, 400K, 400L) during actual mounting and application, the embodiment of the present disclosure further comprises at least one outer casing (470J, 470K, 470L). The outer casing (470J, 470K, 470L) surrounds the rigid circuit board (430J, 430K, 430L) to cover the one or more light-emitting elements 440. The outer casing (470J, 470K, 470L) is light-transmitting to allow light emitted by the one or more light-emitting elements 440 covered by the outer casing (470J, 470K, 470L) to pass through. The outer casing (470J, 470K, 470L) is further disposed around the female terminal 420. The female terminal 420 is limited in the outer casing (470J, 470K, 470L), which prevents the electrode elements of the female terminal 420 from being touched during the gold finger detection process.

Optionally, the outer casing (470J, 470K, 470L) of the light-emitting body (400J, 400K, 400L) comprises a first casing (471J, 471K, 471L) and a second casing (472J, 472K, 472L). The first casing (471J, 471K, 471L) and the second casing (472J, 472K, 472L) are nested together. The second casing (472J, 472K, 472L) covers the female terminal 420, and an inner side of the second casing (472J, 472K, 472L) is spaced apart from the outer side of the female terminal 420. The first casing (471J, 471K, 471L) covers the male terminal 410, and an inner side of the first casing (471J, 471K, 471L) is spaced apart from the outer side of the male terminal 410. During the process of connecting the male terminal 410 and the female terminal 420 to other terminals, at least a portion of the other terminals is plugged into the first casing (471J, 471K, 471L) and the second casing (472J, 472K, 472L). The first casing (471J, 471K, 471L) and the second casing (472J, 472K, 472L) jointly cover the rigid circuit board (430J, 430K, 430L).

A structure of the first casing (471K, 471L) is the same as a structure of the first casing 471J, and a structure of the second casing (472K, 472L) is the same as a structure of the second casing 472J. The embodiments of the present disclosure take the structures of the first casing 471J and the second casing 472J as examples for further illustration.

Optionally, the first casing 471J comprises a first sleeving portion 4711J, a second sleeving portion 4712J, and a first blocking portion 4713J. The first sleeving portion 4711J and the second sleeving portion 4712J are connected and are disposed along a ninth axis P9. The first blocking portion 4713J is disposed at a connection position of the first sleeving portion 4711J and the second sleeving portion 4712J. The first blocking portion 4713J is disposed on an inner side of the first sleeving portion 4711J and an inner side of the second sleeving portion 4712J. The second sleeving portion 4712J is configured to house the male terminal 410. The second casing 472J comprises a third sleeving portion 4721J, a fourth sleeving portion 4722J, and a second blocking portion 4723J. The third sleeving portion 4721J and the fourth sleeving portion 4722J are connected and disposed along the ninth axis P9. The second blocking portion 4723J is disposed at a connection position between the third sleeving portion 4721J and the fourth sleeving portion 4722J. The second blocking portion 4723J is disposed on an inner side of the third sleeving portion 4721J and an inner side of the fourth sleeving portion 4722J. The fourth sleeving portion 4722J is configured to sleeve the female terminal 420. The first sleeving portion 4711J and the third sleeving portion 4721J are both configured to sleeve the rigid circuit board 430J.

The fourth sleeving portion 4711J defines a first subspace 4731J. The third sleeving portion 4721J defines a second subspace 4732J. The first subspace 4731J is communicated with the second subspace 4732J to form a first space 473J. The first space 473J is configured to accommodate the rigid circuit board 430J and the one or more light-emitting elements 440. In some optional embodiments, the first space 473J may further accommodate other components such as a flexible circuit board 450 and a support 460. In the embodiment, the one or more light-emitting elements 440 are directly disposed on the flexible circuit board 450. The flexible circuit board 450 is mounted on the support 460. The flexible circuit board 450 and the rigid circuit board 430J are electrically connected. The support 460 is disposed around the rigid circuit board 430J.

The second sleeving portion 4712J defines a second space 474J and a first opening 475J communicated with the second space 474J. The fourth sleeving portion 4722J defines a third space 477J and a second opening 478J communicated with the third space 477J. The first blocking portion 4713J defines a first through hole 476J, and the second blocking portion 4723J defines a second through hole 479J. The first through hole 476J communicates the second space 474J and the first space 473J. The second through hole 479J communicates the third space 477J and the first space 473J. The male terminal 410 is accommodated in the second space 474J and the first through hole 476J. The female terminal is accommodated in the third space 477J and the second space 479J. In actual assembly, the male terminal 410 is first plugged from the first subspace 4731J into the first through hole 476J, and then further plugged into the second space 474J. The first blocking portion 4713J is configured to prevent the rigid circuit board 430J from entering the second space 474J. Then, the female terminal is plugged from the second subspace 4732J into the second space 479J, and continues into the third space 477J. The second blocking portion 4723J is configured to prevent the rigid circuit board 430J from entering the third space 477J. Finally, the first sleeving portion 4711J and the third sleeving portion 4721J are connected together. It should be noted that it is also feasible to mount the female terminal first and then the male terminal. Optionally, the first sleeving portion 4711J comprises a first connecting structure 4714J, and the third sleeving portion 4721J comprises a second connecting structure 4724J. The first connecting structure 4714J is fixedly connected to the second connecting structure 4724J. Optionally, a connection junction between the first connecting structure 4714J and the second connecting structure 4724J is smoothly transitioned. A connection method of the first connecting structure 4714J and the second connecting structure 4724J comprises, but is not limited to: threaded connection, adhesive connection, snap-fit connection, and hot melt connection.

Optionally, a diameter of the first sleeving portion 4711J is greater than a diameter of the second sleeving portion 4712J.

Optionally, a diameter of the third sleeving portion 4721J is greater than a diameter of the fourth sleeving portion 4722J.

Optionally, the diameter of the first sleeving portion 4711J is equal to the diameter of the third sleeving portion 4721J.

Optionally, the diameter of the second sleeving portion 4712J is equal to the diameter of the fourth sleeving portion 4722J.

Optionally, a diameter of the first blocking portion 4713J is equal to a diameter of the second blocking portion 4723J.

In the embodiment, the one or more light-emitting elements 440 and the rigid circuit board are physically connected directly or indirectly.

In one embodiment, as shown in FIGS. 15A-15B, 18A-18C, 21A-21B, and 24A-24C, the one or more light-emitting elements 440 of the light-emitting body (400A, 400D, 400G, 400J) are indirectly and physically connected to the rigid circuit board (430A, 430D, 430G, 430J). The one or more light-emitting elements 440 are physically and electrically connected to the rigid circuit board (430A, 430D, 430G, 430J) via the flexible circuit board 450. Specifically, the one or more light-emitting elements 440 are disposed on a first side of the flexible circuit board 450, and a second side of the flexible circuit board 450 is disposed around the rigid circuit board (430A, 430D, 430G, 430J). The flexible circuit board 450 is disposed around a peripheral side of the rigid circuit board (430A, 430D, 430G, 430J) to expose at least one end surface of the rigid circuit board (430A, 430D, 430G, 430J), which facilitates an electrical connection between the end surface of the rigid circuit board (430A, 430D, 430G, 430J) and the male terminal 410. Alternatively, the flexible circuit board 450 is positioned at least around the peripheral side of the rigid circuit board (430A, 430D, 430G, 430J) without covering at least one end surface of the rigid circuit board 430A, to ensure that the male terminal 410 is electrically connected to the rigid circuit board (430A, 430D, 430G, 430J). The flexible circuit board 450 is electrically connected to the rigid circuit board (430A, 430D, 430G, 430J) through a wire, or the flexible circuit board 450 is directly soldered to the rigid circuit board (430A, 430D, 430G, 430J) to achieve electrical connection.

In another embodiment, as shown in FIGS. 16, 17, 19, 20, 22, 23, 25, 26, and 27, the one or more light-emitting elements 440 of the light-emitting body (400B, 400C, 400E, 400F, 400H, 400I, 400K, 400L, 400M) are directly physically and electrically connected to the rigid circuit board (430B, 430C, 430E, 430F, 430H, 430I, 430K, 430L, 430M). The one or more light-emitting elements 440 are directly disposed on at least one side of the rigid circuit board (430B, 430C, 430E, 430F, 430H, 430I, 430K, 430L, 430M) and are not disposed on the flexible circuit board.

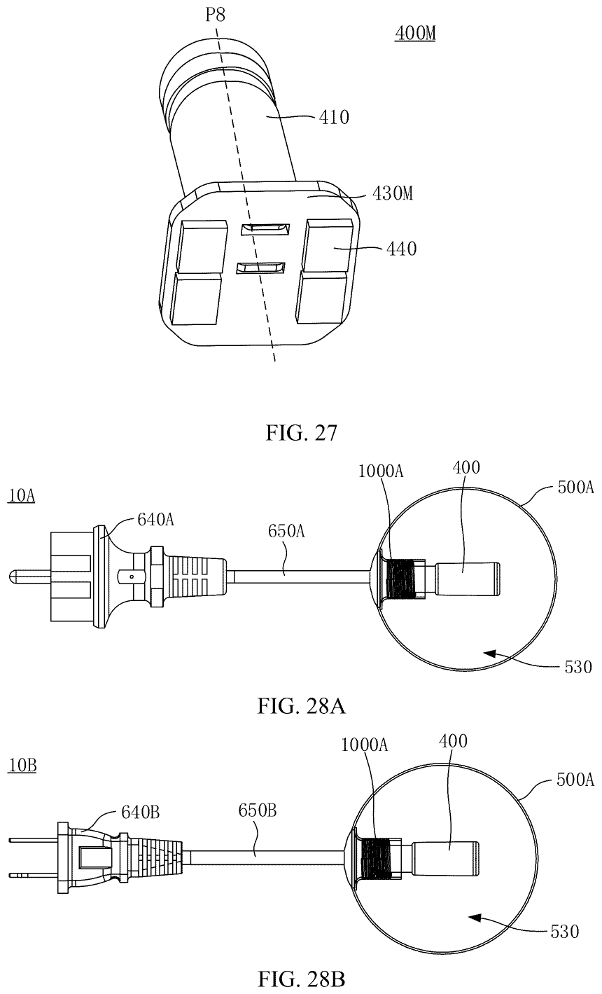

In one optional embodiment, as shown in FIG. 27, the rigid circuit board 430M has two opposite surfaces, and the one or more light-emitting elements 440 are disposed on one of the two opposite surfaces of the rigid circuit board 430M.

In another optional embodiment, as shown in FIGS. 16, 19, 22, and 25, the rigid circuit board (430B, 430E, 430H, 430K) has two opposite surfaces, and the one or more light-emitting elements 440 are disposed on one of the two opposite surfaces of the rigid circuit board (430B, 430E, 430H, 430K). Alternatively, the light-emitting elements 440 are disposed on the two opposite surfaces of the rigid circuit board (430B, 430E, 430H, 430K).

In one optional embodiment, as shown in FIGS. 17, 20, 23, and 26, the rigid circuit board (430C, 430F, 430I, 430L) has at least two boards. Each of the boards defines two opposite surfaces. The light-emitting body 400C shown in FIG. 17 is taken as an example for further illustration. The one or more light-emitting elements 440 comprises light-emitting elements 440. The rigid circuit board 430C comprises a first board 430C1 and a second board 430C2. The first board 430C1 has two opposite surfaces, and at least one of the light-emitting elements 440 is disposed on at least one surface of the first board 430C. The second board 430C2 also has two opposite surfaces, and at least one of the light-emitting elements 440 is disposed on at least one surface of the second board 430C2. The first board 430C1 and the second board 430C2 are fixedly connected. Optionally, the first board 430C1 defines a slot structure for plugging the second board 430C2.

Optionally, as shown in FIGS. 15A, 15B, 18A-8C, 21A, 21B, and 24A-24C, the light-emitting body (400A, 400D, 400G, 400J) further comprise a support 460. A flexible circuit board 450 is mounted on the support 460. The support 460 serves as a carrier for the flexible circuit board 450. The flexible circuit board 450 is electrically connected to the rigid circuit board (430A, 430D, 430G, 430J). The support 460 is disposed around the rigid circuit board 430J.

Optionally, as shown in FIGS. 15A and 15B, the first end 431 and the second end 432 of the rigid circuit board 430A are disposed opposite to each other. The rigid circuit board 430A further comprises a first connecting structure 433 disposed at the second end 432 of the rigid circuit board 430A. The first connecting structure 433 is physically and electrically connected to the male terminal 410. It should be noted that when the second end 432 of the rigid circuit board 430A is connected to the female terminal, the second end 432 of the rigid circuit board 430A is provided with a second connecting structure configured to physically and electrically connect with the female terminal. As shown in FIG. 21B, the rigid circuit board 430G comprises the first connecting structure 431G disposed at the first end thereof and the second connecting structure 432G disposed at the second end thereof. The first connecting structure 431G is physically and electrically connected to the male terminal, and the second connecting structure 432G is physically and electrically connected to the female terminal 420.

Optionally, as shown in FIGS. 15A and 15B, the rigid circuit board 430A further comprises a second limiting structure 436 disposed at the first end 431 thereof and a first limiting structure 435 disposed at the second end 432 thereof. The first limiting structure 435 and the second limiting structure 436 jointly define a limiting slot 437 on one side of the rigid circuit board 430A. The support 460 and a portion of the flexible circuit board 450 are placed in the limiting slot 437, so that the support 460 and the flexible circuit board 450 are limited between the first limiting structure 435 and the second limiting structure 436.

Optionally, as shown in FIGS. 15A-26, the male terminal 410 of the light-emitting body (400A, 400B, 400C, 400D, 400E, 400F, 400G, 400H, 400I, 400J, 400K, and 400L) is disposed at the first end of the rigid circuit board (430A, 430B, 430C, 430D, 430E, 430F, 430G, 430H, 430I, 430J, 430K, and 430L). In the embodiments, the rigid circuit board (430A, 430B, 430C, 430D, 430E, 430F, 430G, 430H, 430I, 430J, 430K, 430L) is connected to one terminal, namely the male terminal 410, or to two terminals, namely the male terminal 410 and the female terminal 420.

For instance, shown in FIG. 27, the male terminal 410 of the light-emitting body 400M is disposed on a first side of the rigid circuit board 430M, and the one or more light-emitting elements 440 are disposed on a second side of the rigid circuit board 430M. In the embodiment, the rigid circuit board 430M is connected to only one terminal, that is, the male terminal 410, and the rigid circuit board 430M is not connected to the female terminal.

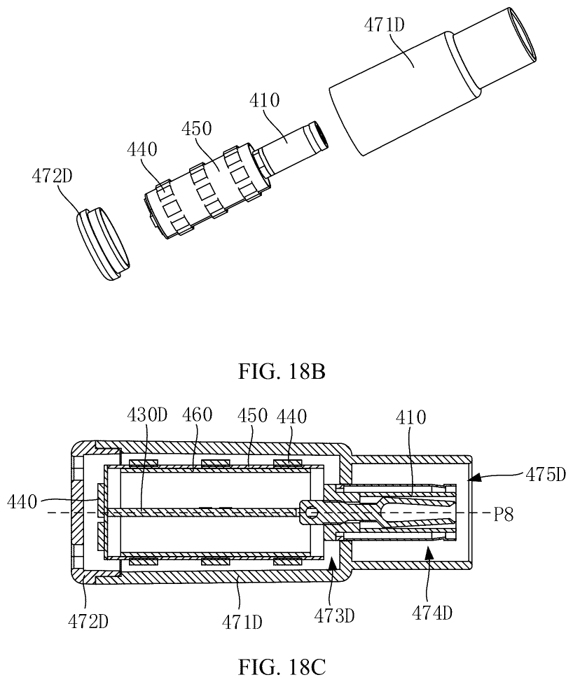

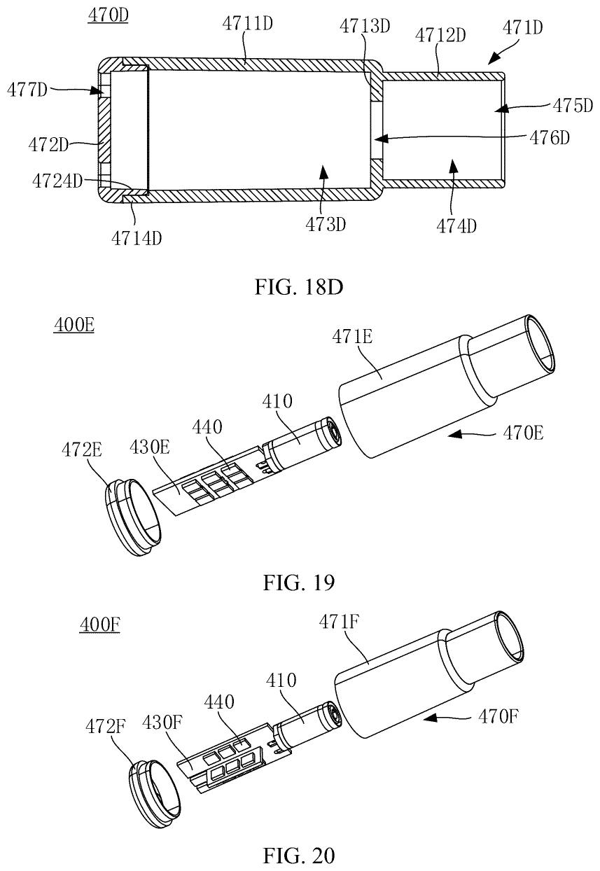

In other optional embodiments, as shown in FIGS. 18A-20, when the light-emitting body (400D, 400E, 400F) comprises only the male terminal 410 and does not comprise the female terminal, the light-emitting body (400D, 400E, 400F) further comprises an outer casing (470D, 470E, 470F). The outer casing (470D, 470E, 470F) is disposed around the rigid circuit board (430D, 430E, 430F) to cover at least one of the one or more light-emitting elements 440. The outer casing (470D, 470E, 470F) is light-transmitting to allow light emitted by the one or more light-emitting elements 440 covered by the outer casing (470D, 470E, 470F) to pass through. The outer casing (470D, 470E, 470F) is further disposed around the male terminal 410. The male terminal 410 is limited in the outer casing (470D, 470E, 470F).

Optionally, the outer casing (470D, 470E, 470F) of the light-emitting body (400D, 400E, 400F) comprises a first casing (471D, 471E, 471F) and a second casing (472D, 472E, 472F). The first casing (471D, 471E, 471F) and the second casing (472D, 472E, 472F) are nested together. The first casing (471D, 471E, 471F) covers the male terminal 410, and an inner side of the first casing (471D, 471E, 471F) is spaced apart from the outer side of the male terminal 410. During the plugging process of the male terminal 410 and the female terminal 420, at least a portion of the female terminals is plugged into the first casing (471D, 471E, 471F). The first casing (471D, 471E, 471F) and the second casing (472D, 472E, 472F) jointly cover the rigid circuit board (430D, 430K, 430L).

A structure of the first casing (471E, 471F) is the same as a structure of the first casing 471D, and a structure of the second casing (472E, 472F) is the same as a structure of the second casing 472D. The embodiments of the present disclosure take the structures of the first casing 471D and the second casing 472D as examples for further illustration.

Optionally, the first casing 471D comprises a first sleeving portion 4711D, a second sleeving portion 4712D, and a blocking portion 4713D. The first sleeving portion 4711D and the second sleeving portion 4712D are connected and are disposed along the ninth axis P8. The blocking portion 4713D is disposed at a connection position of the first sleeving portion 4711D and the second sleeving portion 4712D. The blocking portion 4713D is disposed on an inner side of the first sleeving portion 4711D and an inner side of the second sleeving portion 4712D. The second sleeving portion 4712D is configured to house the male terminal 410. The first sleeving portion 4711D and the second casing 472D are configured to sleeve the rigid circuit board 430D.

The first sleeving portion 4711D and the second casing 472D jointly define a first space 473D. The first space 473D is configured to accommodate the rigid circuit board 430D and the one or more light-emitting elements 440. In some optional embodiments, the first space 473D may further accommodate other components such as the flexible circuit board 450 and the support 460. In the embodiment, the one or more light-emitting elements 440 are directly disposed on the flexible circuit board 450. The flexible circuit board 450 is mounted on the support 460. The flexible circuit board 450 and the rigid circuit board 430D are electrically connected. The support 460 is disposed around the rigid circuit board 430D.

The second sleeving portion 4712D defines a second space 474D and a first opening 475D communicated with the second space 474D. The blocking portion 4713D defines a first through hole 476D, and the second blocking portion 4723J defines a second through hole 477D. The first through hole 476D communicates the second space 474D and the first space 473D. The second through hole 477D communicates the first space 473D. The male terminal 410 is accommodated in the second space 474D and the first through hole 476D. In actual assembly, the male terminal 410 is first plugged from the first sleeving portion 4711D into the first through hole 476D, and then further plugged into the second space 474D. The blocking portion 4713D is configured to prevent the rigid circuit board 430D from entering the second space 474D. Finally, the first sleeving portion 4711D and the second casing 472D are connected together. It should be noted that it is also feasible to mount the female terminal first and then the male terminal. Optionally, the first sleeving portion 4711D comprises a first connecting structure 4714D, and the second casing 472D comprises a second connecting structure 4724D. The first connecting structure 4714D is fixedly connected to the second connecting structure 4724D. Optionally, a connection junction between the first connecting structure 4714D and the second connecting structure 4724D is smoothly transitioned. A connection method of the first connecting structure 4714D and the second connecting structure 4724D comprises, but is not limited to: threaded connection, adhesive connection, snap-fit connection, and hot melt connection. During the plugging process between the male terminal 410 and the female terminal, at least a portion of the female terminal is plugged from the opening 475D into the second sleeving portion 4712D.

Optionally, a diameter of the first sleeving portion 4711D is greater than a diameter of the second sleeving portion 4712D.

Optionally, a diameter of the second casing 472D is equal to the diameter of the first sleeve portion 4711D.

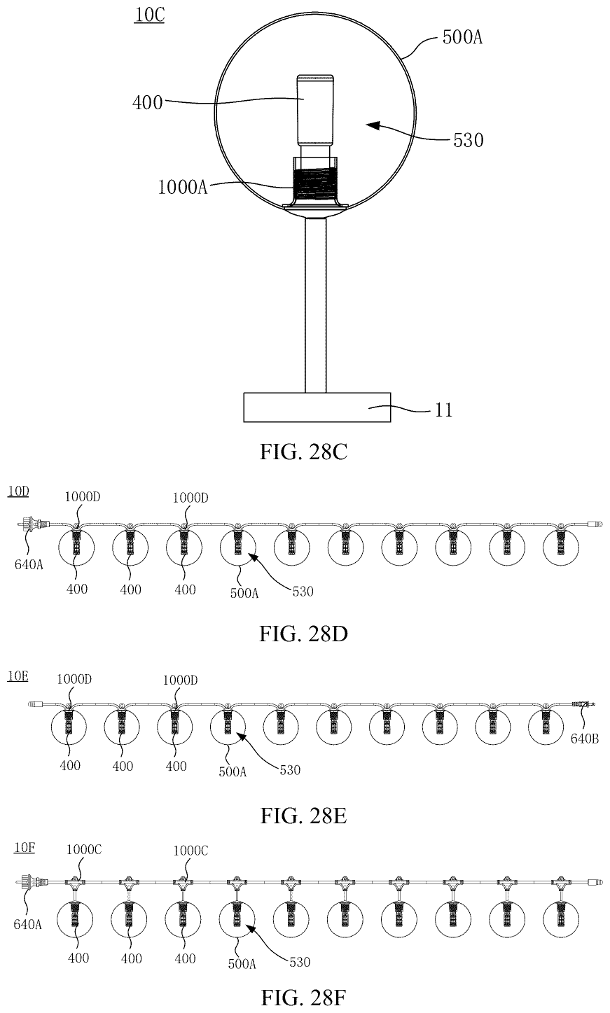

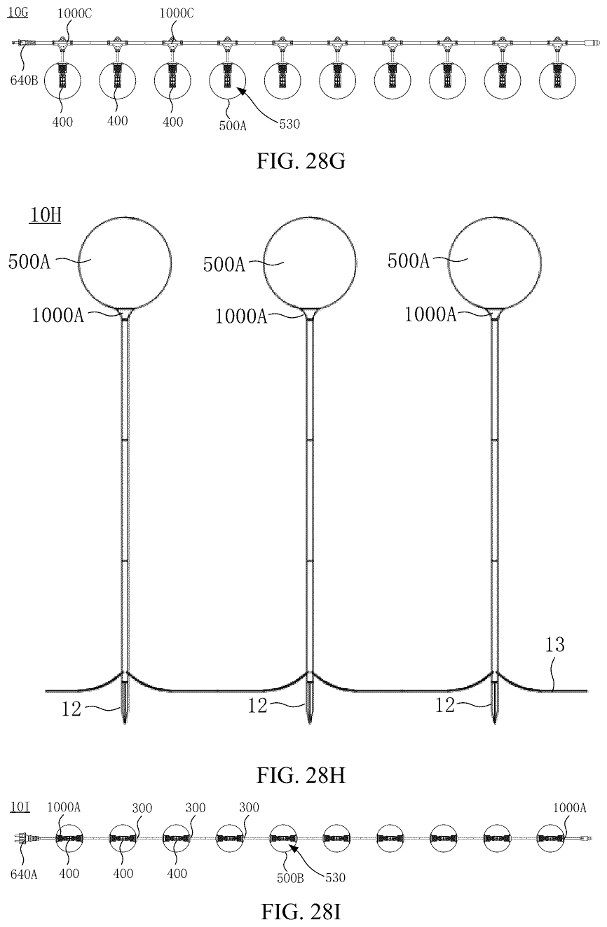

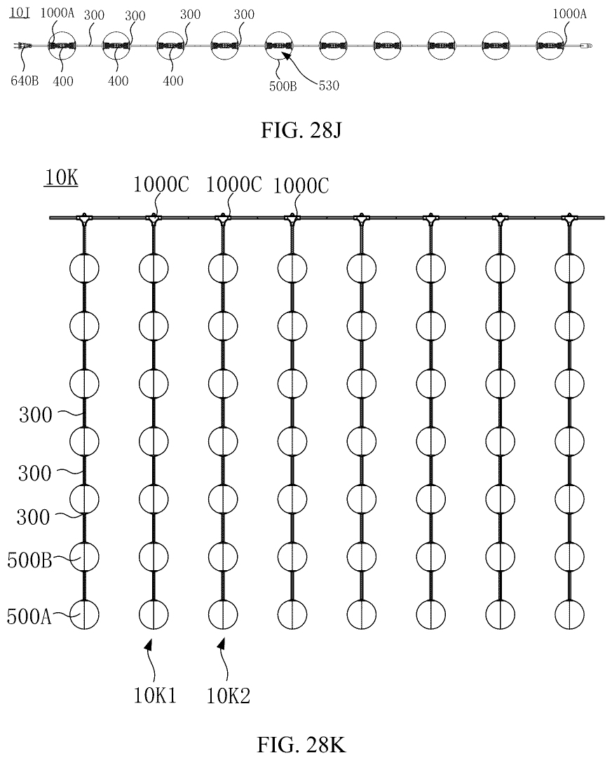

As shown in FIGS. 28A-28K, embodiments of the present disclosure further provide a lamp powered by mains power (10A, 10B, 10C, 10D, 10E, 10F, 10G, 10H, 10I, 10J, 10K, abbreviated as 10A-K). The lamp powered by the mains power (10A-K) is referred to as lamp (10A-K) described below. The lamp (10A-K) comprises at least one lampshade (500A, 500B), at least one light-emitting body 400, at least one electrical connecting device (1000A, 1000C, 1000D), and an electrical plug (640A, 640B).

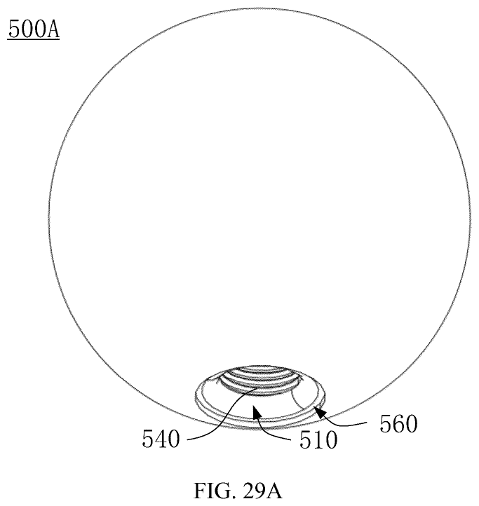

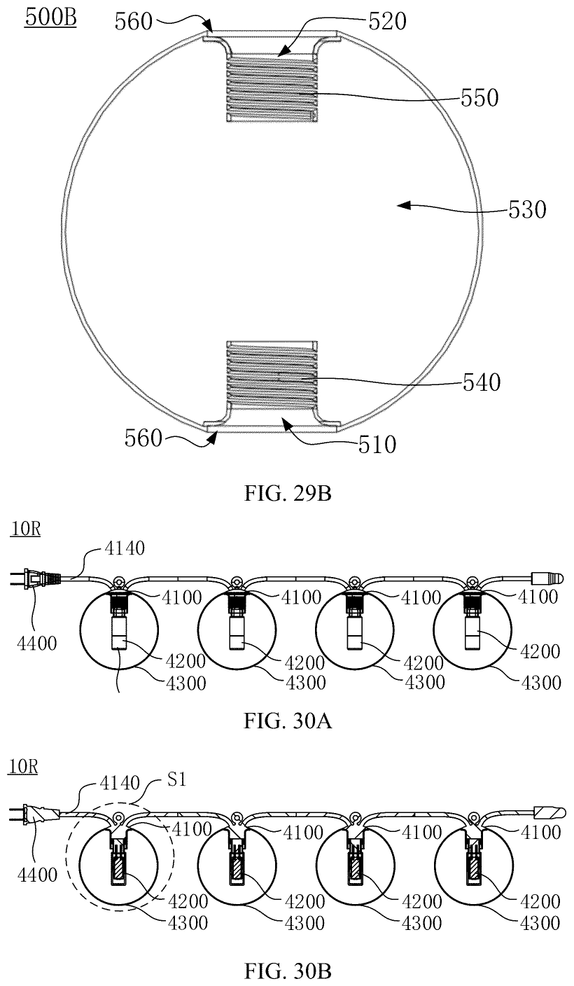

As shown in FIGS. 29A and 29B, the present disclosure takes one lampshade of the at least one lampshade as an example for further illustration. The lampshade (500A, 500B) comprises an accommodating space 530 and at least one opening (510, 520) communicated with the accommodating space 530. Specifically, the lampshade 500A comprises the accommodating space 530 and an opening 510 communicated with the accommodating space 530; in the embodiment, the opening 510 is defined as a first opening 510. The lampshade 500A further comprises an internal thread 540 disposed at the first opening 510; in the embodiment, the internal thread 540 is defined as a first internal thread 540. The lampshade 500A further comprises a mounting groove 560 disposed at the first opening 510. The mounting groove 560 is disposed on an outer side of the first opening 510.

As shown in FIGS. 15A and 15B, the connecting piece 1100 in the electrical connecting device 1000A further comprises a mounting structure 1115 disposed on the second end surface 1112 of the connecting piece 1100. The mounting structure 1115 is disposed around the second end surface 1112 of the connecting piece 1100. After the outer thread 1114 is screwed with the first internal thread 340 of the lampshade (500A, 500B), the mounting structure 1115 is attached to an outer surface of the lampshade (500A, 500B). To increase connection stability between the electrical connecting device 1000A and the lampshade (500A, 500B), after the outer thread 1114 is screwed with the first internal thread 340 of the lampshade (500A, 500B), the mounting structure 1115 is placed in the mounting groove 560, and a surface at a connection joint between the mounting structure 1115 and the lampshade (500A, 500B) is smoothly transitioned, ensuring a smooth connection at the connection joint thereof.

Alternatively, the lampshade 500B comprises an accommodating space 530, a first opening 510 and a second opening 520. The first opening 510 and the second opening 520 are communicated with the accommodating space 530. Specifically, the first opening 510 and the second opening 520 are opposite to each other. The lampshade 500B further comprises a first internal thread 540 disposed at the first opening 510 and a second internal thread 550 disposed at the second opening 520. The lampshade 500A further comprises a mounting groove 560 disposed at the outer side of the first opening 510 and a mounting groove 560 disposed at an outer side of the second opening 520. Further, the two mounting grooves 560 are configured to be respectively connected to mounting structures 1115 of another two electrical connecting devices 1000A.

The at least one light-emitting body 400 comprises one or more light-emitting bodies. The embodiment takes one light-emitting body 400 as an example for further illustration. The light-emitting body 400 comprises a rigid circuit board and light-emitting elements electrically connected to the rigid circuit board. The rigid circuit board is connected to a male terminal. A structure of the male terminal may be referenced to the male terminal 200A or the male terminal 200B and is not described in detail herein. In one optional embodiment, a structure of the light-emitting body 400 may be referenced to the light-emitting body (400A, 400B, 400C, 400D, 400E, 400F, 400M) and is not described in detail herein. In another optional embodiment, the light-emitting body 400 further comprises a female terminal. A structure of the light-emitting body 400 including the female terminal may be referenced to the light-emitting body (400G, 400H, 400I, 400J, 400K, 400L) and is not described in detail herein.

The light-emitting body 400 is allowed to be plugged into the accommodating space 530 of the lampshade 500 through any one of the two openings (510, 520), and the light-emitting body 400 is allowed to be removed from the accommodating space 530 through any one of the two openings (510, 520).

The at least one electrical connecting device (1000A, 1000C, 1000D) may be referred to the above description and is not repeatedly described herein. It should be noted that it is also feasible to replace the electrical connecting device 1000C or the electrical connecting device 1000D in some lamps with the electrical connecting device 1000B.

The at least one electrical connecting device (1000A, 1000C, 1000D) comprises one or more electrical connecting devices. The embodiment takes one electrical connecting device (1000A, 1000C, 1000D) as an example for further illustration. The female terminal 100 of the electrical connecting device (1000A, 1000C, 1000D) is able to be plugged into and detached from the male terminal 410 of the light-emitting body 400. At least a portion of the female terminal 100 of the electrical connecting device (1000A, 1000C, 1000D) is allowed to be plugged together with the light-emitting body 400 into the accommodating space 530 of the lampshade (500A, 500B) through any one of the two openings (510, 520). The connecting piece 1100 of the electrical connecting device (1000A, 1000C, 1000D) is detachably connected to the lampshade (500A, 500B). For example, the outer thread 1124 of the connecting piece 1100 is detachably connected to the first internal thread 540 or the second internal thread 550 of the lampshade (500A, 500B).

For instance, during or after the plugging process of the male terminal 410 of the light-emitting body 400 and the female terminal 100 of the electrical connecting device (1000A, 1000C, 1000D), the male terminal 410 of the light-emitting body 400 and the female terminal 100 of the electrical connecting device (1000A, 1000C, 1000D) are rotatable relative to each other, which allows the electrical connecting device (1000A, 1000C, 1000D) and the lampshade (500A, 500B) to be screwed together.

During or after the plugging process of the male terminal 410 of the light-emitting body 400 and the female terminal 100 of the electrical connecting device (1000A, 1000C, 1000D), the first portion 211 of the third electrode element 210 presses the first portion (110A, 110B) of the first electrode element (100A, 100B) to cause the elastic deformation of the first portion (110A, 110B) of the first electrode element (100A, 100B), thereby ensuring that the first portion 211 of the third electrode element closely contacts contact the first portion (110A, 110B) of the first electrode element (100A, 100B). Meanwhile, the first portion 121 of the second electrode element 120 presses the first portion (221A, 221B) of the fourth electrode element (220A, 220B) to cause the elastic deformation of the first portion (221A, 221B) of the fourth electrode element (220A, 220B), thereby ensuring that the first portion 121 of the second electrode element 120 closely contacts the first portion (221A, 221B) of the fourth electrode element (220A, 220B).

After the male terminal 410 of the light-emitting body 400 is completely plugged into the female terminal 100 of the electrical connecting device (1000A, 1000C, 1000D), the first portion 211 of the third electrode element 210 and the outer spacer 231 are located within the first spacing space 101, and the first portion 211 of the third electrode element 210 contacts the abutting portions (115A, 115B) of the first electrode element (100A, 100B). The first portion (221A, 221B) of the fourth electrode element (220A, 220B) and the inner spacer 233 are disposed in the second spacing space 102, and the first portion 121 of the second electrode element 120 is disposed in the plugging space (2214A, 2214B) of the fourth electrode element (220A, 220B). The first portion 121 of the second electrode element 120 contacts the first portion (221A, 221B) of the fourth electrode element (220A, 220B), so as to realize the electrical connection between the male terminal 410 of the light-emitting body 400 and the female terminal 100 of the electrical connecting device (1000A, 1000C, 1000D). The first portion 211 of the third electrode element 210 and the first portion (110A, 110B) of the first electrode element (100A, 100B) are spaced apart from the first portion 121 of the second electrode element 120 and the first portion (221A, 221B) of the fourth electrode element (220A, 220B) by at least the inner spacer 233, the outer spacer 231 and the spacer 131 of the female base 130.

A plugging state and a separated states of the male terminal 410 of the light-emitting body 400 and the female terminal 100 of the electrical connecting devices (1000A, 1000C, 1000D) may be referred to the terminal assembly shown in FIGS. 9A-9L, which are not described in detail herein.

The electrical plug (640A, 640B) is electrically connected to the female terminal 100 of one of the at least one electrical connecting device (1000A, 1000C, 1000D), and the electrical plug (640A, 640B) is configured to connect to the mains power. For example, the electrical plug (640A, 640B) is configured to be plugged into a socket connected to mains power.

In one optional embodiment, as shown in FIGS. 28A-28C, the lamp (10A, 10B, 10C) comprises the lampshade 500A, the light-emitting body 400, and the electrical connecting device 1000A. The female terminal 100 of the electrical connecting device 1000A of the lamp 10A is electrically connected to the electrical plug 640A via a wire 650A. The female terminal 100 of the electrical connecting device 1000A of the lamp 10B is electrically connected to the electrical plug 640B via a wire 650B. The female terminal 100 of the electrical connecting device 1000A of lamp 10C is electrically connected to the electrical plug via a wire, and the connecting piece 1100 of the electrical connecting device 1000A of the lamp 10C is connected to a support base 11. The support base 11 supports the lampshade 500A, the electrical connecting device 1000A, and the light-emitting body 400. The support base 11 is able to be placed in a predetermined position, such as on the ground or a table. It should be noted that the support base 11 may be replaced with a ground spike. For instance, the support base 11 may be replaced with one of ground spikes 12 shown in FIG. 28H.

In one optional embodiment, as shown in FIGS. 28D, 28E, 28F, and 28G, the lamp (10D, 10E, 10F, 10G) comprises lampshades 500A, light-emitting bodies 400, and electrical connecting devices (1000C, 1000D). Specifically, the number of the lampshades 500A, the number of the light-emitting bodies 400, and the number of the electrical connecting devices (1000C, 1000D) are the same. It should be noted that the electrical connecting devices (1000C, 1000D) in the lamp (10D, 10E, 10F, 10G) of the embodiments of the present disclosure may be replaced with a plurality of electrical connecting devices 1000B. The female terminals 100 of each two adjacent electrical connecting devices (1000C, 1000D) are connected by a corresponding one of wires. In the embodiments, the outer thread 1114 of each of the electrical connecting devices (1000C, 1000D) is connected to the first internal thread 540 disposed at the first opening 510 of a corresponding one of the lampshades 500A, and the female terminal 100 of each of the connecting devices (1000C, 1000D) is plugged into the male terminal 410 of a corresponding one of the light-emitting bodies 400. The lamp (10D, 10E, 10F, 10G) is defined as a string light. FIGS. 10D and 10F illustrate a first embodiment of the electrical plug 640A, and FIGS. 10E and 10G illustrate a second embodiment of the electrical plug 640B. The electrical plug 640A is different from the electrical plug 640B.

In one optional embodiment, as shown in FIG. 28H, the lamp 10H comprises lampshades 500A, light-emitting bodies 400, and electrical connecting devices 1000A. Specifically, the number of the lampshades 500A, the number of the light-emitting bodies, and the number of the electrical connecting devices 1000A are the same. Each of the electrical connecting devices 1000A is physically connected to a corresponding one of ground spikes 12, and the female terminal 100 of each of the electrical connecting devices 1000A is electrically connected to a corresponding one of wires 13.

In one optional embodiment, as shown in FIGS. 281 and 28J, the lamp (101, 10J) comprises lampshades 500B, light-emitting elements 400, and electrical connecting devices (1000A). Specifically, the number of the lampshades 500A and the number of the light-emitting bodies 400 are the same. The lamp may comprise one electrical connecting device 1000A or two electrical connecting devices 1000A. The embodiment takes two electrical connecting devices 1000A as an example for further illustration. Specifically, a first electrical connecting device 1000A connected to a first lampshade of the lamp is connected to the electrical plug (640A, 640B), and a second electrical connecting device 1000A is connected to a last lampshade (i.e., the closed end of the lamp). The closed end of the lamp (101, 10J) and the electrical plug (640A, 640B) are located at two opposite ends of the lamp (101, 10J). When there is only one electrical connecting device 1000A connected to one of the lampshades (i.e., the last lampshade), the last lampshade disposed at a tail end of the lamp (101, 10J) and furthest from the electrical plugs (640A, 640B) adopts the structure of the lampshade 500A, while the other lampshades adopt the structure of the lampshade 500B.

The lamp (101, 10J) further comprises at least one terminal assembly 300. The at least one terminal assembly 300 comprises one or more terminal assemblies 300. The embodiment takes one terminal assembly 300 as an example for further illustration. The terminal assembly 300 is one of the terminal assembly 300B, the terminal assembly 300C, or the terminal assembly 300D. The terminal assembly 300 comprises a male terminal and a female terminal. The male terminal and the female terminal are connected via a corresponding one of the wire or the male terminal and the female terminal are directly connected. The terminal assembly 300 is physically connected to two adjacent lampshades 500B, and the terminal assembly 300 is detachable from the two adjacent lampshades 500B. Specifically, the first outer thread and the second outer thread of the terminal assembly 300 are respectively screwed with the first internal thread and the second internal thread of the two adjacent lampshades 500B. The male terminal of the terminal assembly 300 is plugged into the female terminal of the light-emitting body 400 disposed in one of the two adjacent lampshades 500B, and the female terminal of the terminal assembly 300 is plugged into the male terminal of the light-emitting body 400 disposed in the other one of the two adjacent lampshades 500B. The male terminal of the terminal assembly 300 and the male terminal of each of the light-emitting bodies 400 may refer to the male terminal 200A or the male terminal 200B. The female terminal of the terminal assembly 300 and the female terminal of each of the light-emitting bodies 400 may refer to the female terminal 100A or the female terminal 100B, which are not described in detail herein.

Optionally, each of the light-emitting bodies 00 in the lamp (101, 10J) further comprises the outer casing. For each of the light-emitting bodies 400, the outer casing thereof surrounds the rigid circuit board thereof to cover the light-emitting elements thereof, the outer casing thereof is light-transmitting to allow light emitted by the light-emitting elements thereof covered by the outer casing thereof to pass through. For each of the light-emitting bodies 400, the outer casing thereof further surrounds the female terminal thereof to limit the female terminal thereof in the outer casing thereof. After the male terminal of each of the light-emitting bodies 400 and the female terminal of each terminal assembly 300 are plugged in, a portion of the female terminal of each terminal assembly 300 is surrounded by each outer casing. Each outer casing may be referenced to the outer casing 470J, which is not described in detail herein.

In one optional embodiment, as shown in FIG. 28K, the lamp 10K comprises light strings, such as a first light string 10K1 and a second light string K2. Each of the first light string 10K1 and the second light string K2 may be referenced to the lamp 10I and the lamp 10J. Each of the first light string 10K1 and the second light string K2 comprises one or two electrical connecting devices, such as electrical connecting devices 1000C, at least one terminal assembly 300, and lampshades 500B. It should be noted that in the embodiment, each of the light strings, that is, each of the first light string 10K1 and the second light string K2, comprises a lampshade 500A that is allowed to be replaced with the lampshade 500B. The light strings, such as the first light string 10K1 and the second light string K2, are physically and electrically connected by wires.

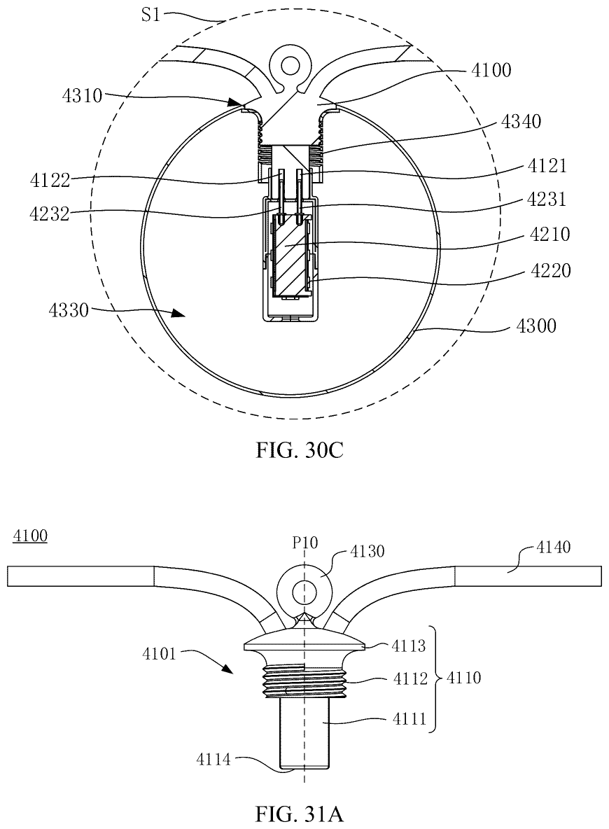

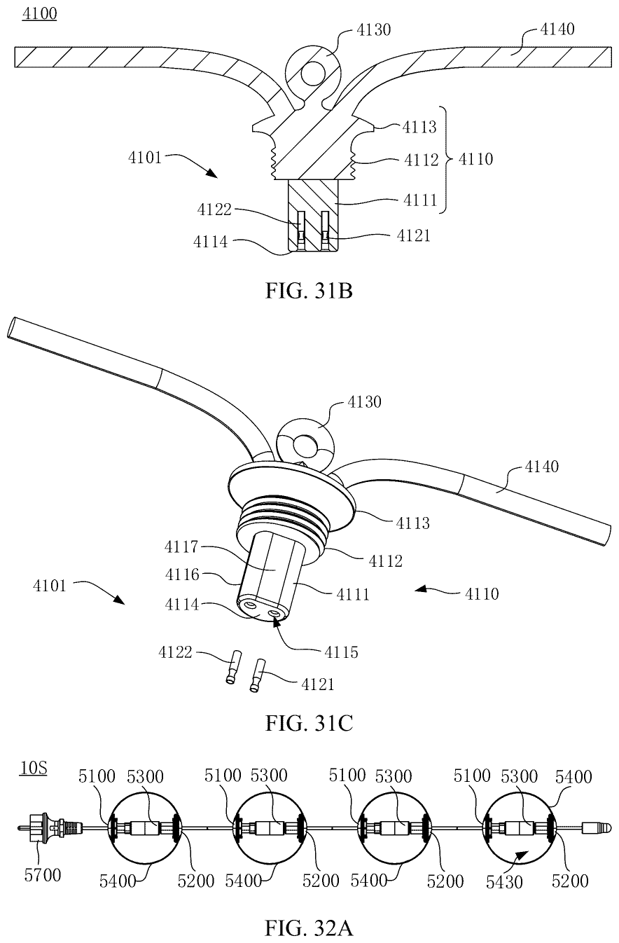

In other optional embodiments, as shown in FIGS. 30A-31C, the embodiment further provides a connecting device 4100 connected to the mains power and a lamp 10R including one or more connecting devices 4100. The lamp 10R comprises one or more light-emitting bodies 4200, one or more lampshades 4300 and one or more connecting devices 4100. For ease of illustration, the embodiment takes one light-emitting body 4200, one connecting device 4100 as an example for further illustration.

The lampshade 4300 comprises an opening 4310 and an accommodating space 4330 communicated with the opening 4310. The light-emitting body 4200 comprises a rigid circuit board 4210, one or more light-emitting elements 4220 electrically connected to the rigid circuit board 4210, a male terminal 4230 physically connected to and electrically connected to the rigid circuit board 4210. The male terminal 4230 comprises electrode elements (4231, 4232); The components of the light-emitting body 4200 other than the male terminal 4230 may be referred to as the light-emitting body (400A, 400B, 400C, 400D, 400E, 400F, 400M), which is not described in detail herein.

The connecting device (4100) comprises a female terminal 4101. The female terminal 4101 comprises a female base 4110 and electrode elements (4121, 4122). The female base 4110 is made of the insulating material, and the electrode elements (4121, 4122) of the female terminal 4101 are disposed in the female base 4110 and are spaced apart by an insulating structure in the female base 4110. The female terminal 4101 is connectable to and separable from the lampshade 4300.

The female base 4110 comprises a plug-in end surface 4114 and two electrode grooves 4115 penetrating through the plug-in end surface 4114. The electrode elements (4121, 4122) of the female terminal 4101 are one-to-one disposed in the electrode grooves 4115. A distance between any one of the electrode elements (4121, 4122) of the female terminal 4101 and the plug-in end surface 4114 of the female terminal 4101 is greater than 0, so that the electrode elements (4121, 4122) of the female terminal 4101 are respectively limited inside the electrode grooves 4115 of the female base 4110. During the gold finger detection process, any of the electrode elements (4121, 4122) of the female terminal 4101 is not touched.

The electrode elements (4231, 4232) of the male terminal 4230 are detachably plugged with the electrode elements (4121, 4122) of the female terminal 4101. When the electrode elements (4231, 4232) of the male terminal 4230 are plugged with the electrode elements (4121, 4122) of the female terminal 4101, the electrode elements (4231, 4232) of the male terminal 4230 are respectively electrically connected to the electrode elements (4121, 4122) of the female terminal 4101. Specifically, a first electrode element 4121 of the female terminal 4101 and a third electrode element 4231 of the male terminal 4230 are positive electrodes and are pluggable with each other to achieve electrical connection. A second electrode element 4122 of the female terminal 4101 and a fourth electrode element 4232 of the male terminal 4230 are negative electrodes and are pluggable with each other to achieve electrical connection.

Optionally, the lampshade 4300 further comprises an internal thread 4340 disposed at the opening 4310. The female terminal 4101 further comprises an outer thread 4112 disposed on an outer side surface thereof. The outer thread 4112 of the female base 4110 is configured to be screwed with the internal thread 4340 of the at least one lampshade 4300. When the electrode elements (4231, 4232) of the male terminal 4230 are plugged with the electrode elements (4121, 4122) of the female terminal 4101, the light-emitting body 4200 and the connecting device (4100) are rotatable together around an axis, such as an axis P10.

Optionally, the lampshade 4300 further comprises a mounting groove communicated with the opening 4310. The female terminal 4101 further comprises a mounting portion 4113. The mounting portion 4113 is adjacent to the outer thread 4112. When the internal thread 4340 is screwed with the outer thread 4112, the mounting portion 4113 is mounted in the mounting groove. The mounting groove of the lampshade 4300 may be referred to any mounting groove 560, which is not described in detail herein.

Optionally, the female terminal 4101 comprises an outer thread 4112 and a mounting portion 4113, and the female base 4110 comprises a plug-in portion 4111. The plug-in portion 4111, the outer thread 4112, and the mounting portion 4113 are sequentially disposed along an axis, such as a tenth axis P10, of the female terminal 4101. The plug-in end surface 4114 of the female terminal 4101 is disposed on one end of the plug-in portion 4111 away from the outer thread 4112. The outer thread 4112 and the mounting portion 4113 are disposed on an outer side surface of the female base 4110. An outer diameter of the plug-in portion 4111, an outer diameter of the outer thread 4112, and an outer diameter of the mounting portion 4113 sequentially increase.

Optionally, the outer side surface of the plug-in portion 4111 comprises an arc-shaped surface 4116 and a flat surface 4117, and the arc-shaped surface 4116 and the flat surface 4117 are connected to each other. In other alternative embodiments, the outer side surface of the plug-in portion 4111 may have other structures, such as a ring structure.

The first electrode element 4121, the second electrode element 4122, and the outer thread 4112 of the female terminal 4101 are rotatable together around the axis, such as the tenth axis P10. In the embodiment, the first electrode element 4121 and the second electrode element 4122 are not coaxially disposed. For instance, the first electrode element 4121 and the second electrode element 4122 are disposed side by side.

In the embodiment, in a connecting state, the light-emitting body 4200 and the female terminal 4101 are rotatable together around the axis, such as the tenth axis P10. For instance, the connected light-emitting body 4200 and the female terminal 4101 are rotatable relative to the lampshade 4300 to achieve the connection and disconnection of the female terminal 4101 and the lampshade 4300.

Optionally, the connecting device 4100 further comprises a mounting body 4130 connected to the female base 4110. The mounting body 4130 is disposed on one end of the connecting device 4100 away from the electrode grooves 4115. The mounting body 4130 may be referenced to the mounting body 1130B, the mounting body 1130C, and the mounting structure 1130D, which are not described in detail herein.

Optionally, the connecting device 4100 is connected to another connecting device 4100 via a wire 4140, and the connecting device 4100 is connected to the electrical plug 4400 via another wire 4140. It should be noted that the electrical plug 4400 may refer to the electrical plug 640B or the electrical plug 640A, which is not described in detail herein.

In the embodiment, the electrode elements of the female terminal of the connecting device 4100 and the electrode elements of the female terminal of the light-emitting body 4200 comprise insulating structures and are spaced apart in the insulating structures to achieve physical isolation and prevent the short circuit.

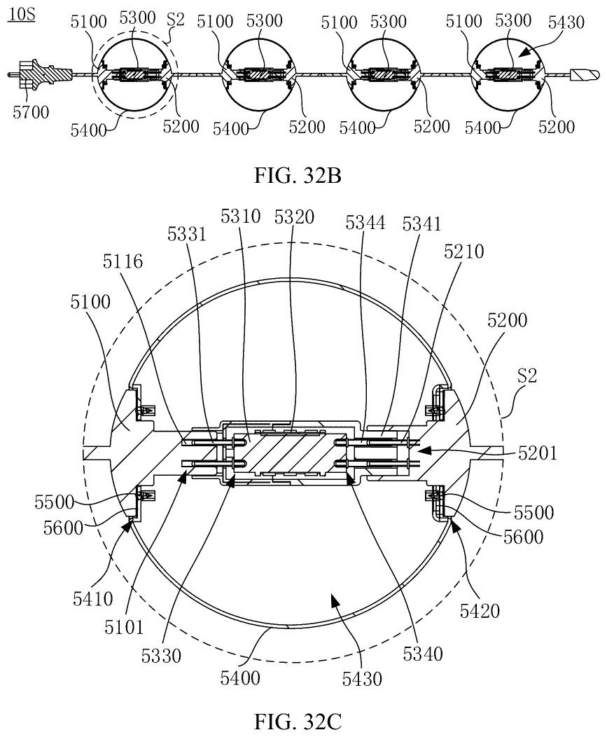

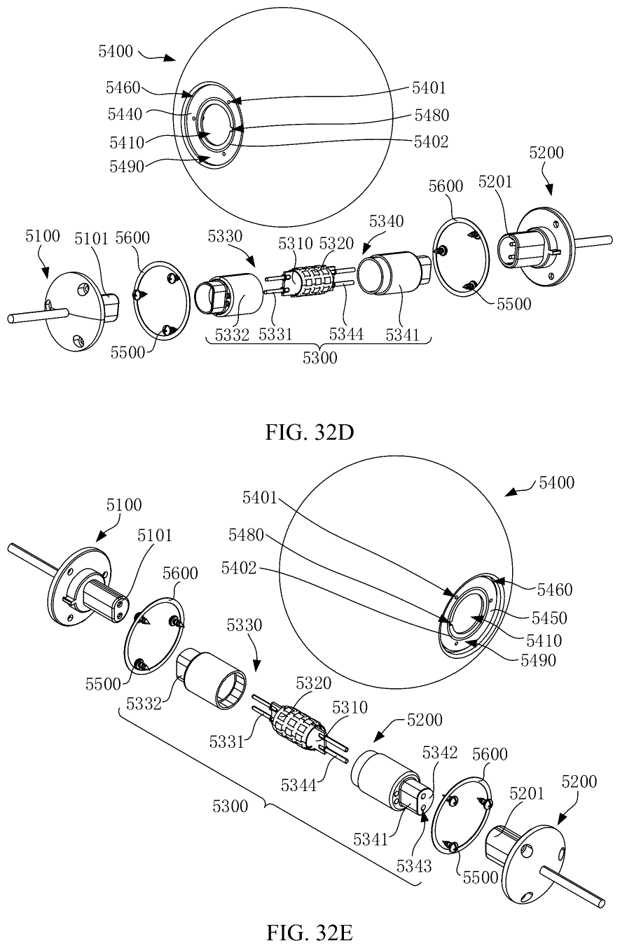

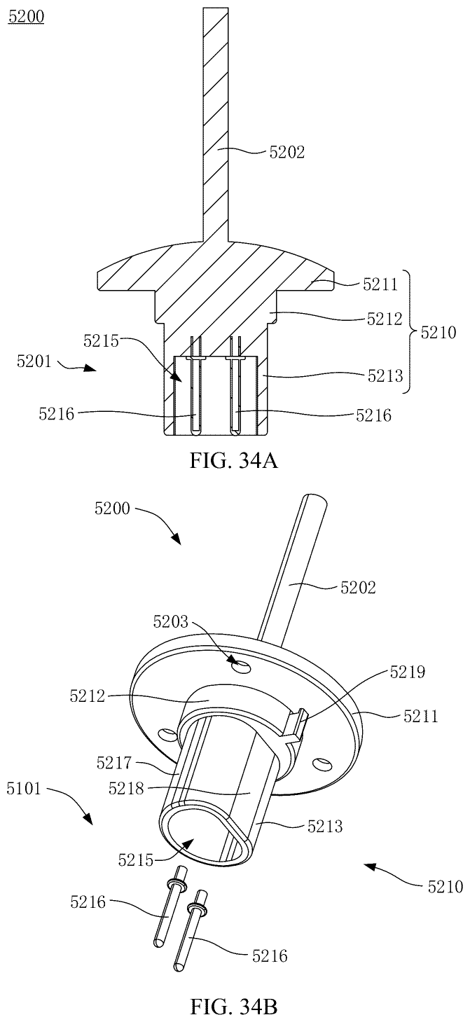

In other optional embodiments, as shown in FIGS. 32A-34B, the embodiments further provide a connecting device 5100 connected to the mains power and a lamp 10S including one or more connecting devices 5100. The lamp 10S comprises light-emitting bodies 5200, lampshades 5300 and connecting devices 4100.

Each of the lampshades 5400 comprises a first opening 5410, a second opening 5420, and an accommodating space (5430) communicated with the first opening 5410 and the second opening 5420. Each of the light-emitting bodies 5300 comprises a rigid circuit board 5310, one or more light-emitting elements 5320 electrically connected to the rigid circuit board 5310, a female terminal 5340, and a male terminal 5330. The female terminal 5340 thereof and the male terminal 5330 thereof are physically connected to and electrically connected to the rigid circuit board 5310 thereof.

Both of the female terminal 5340 and the male terminal 5330 of each of the light-emitting bodies 5300 comprise electrode elements, and the electrode elements 5344 of the female terminal 5340 of each of the light-emitting bodies 5300 are disposed in a first insulating structure. For instance, each of the light-emitting bodies 5300 further comprises an insulating component 5341 made of an insulating material. The electrode elements 5344 of the female terminal 5340 of each of the light-emitting bodies 5300 are disposed on the insulating component 5341, so that the electrode elements 5344 of the female terminal 5340 are not touched during a gold finger detection process.

Each of the first connecting devices 5100 comprises a female terminal 5101. The female terminal 5101 of each of the first connecting devices 5100 comprises electrode elements 5116, and the electrode elements 5116 of the female terminal 5101 of each of the first connecting devices 5100 are disposed in a second insulating structure. For instance, the female terminal 5101 of each of the first connecting devices 5100 comprises an insulating component 5110 made of the insulating material, and the electrode elements 5116 of the female terminal 5101 of each of the first connecting devices 5100 are disposed within the insulating component 5110 thereof, so that the electrode elements 5116 of the female terminal 5101 of each of the first connecting devices 5100 are not touched during the gold finger detection process. Optionally, the electrode elements 5116 of the female terminal 5101 of each of the first connecting devices 5100 are not coaxially disposed.

Each of the second connecting devices 5200 comprises a male terminal 5201, and the male terminal 5201 of each of the second connecting devices 5200 comprises electrode elements 5216. The electrode elements 5216 of the male terminal 5201 of each of the second connecting devices 5200 may be exposed or surrounded by a third insulating structure. For instance, the male terminal 5201 of each of the second connecting devices 5200 comprises an insulating component 5210 made of the insulating material, and at least a portion of the male terminal 5201 of each of the second connecting devices 5200 is disposed within the insulating component 5210.

Each of the lampshades 5400 is connected between a corresponding one of the first connecting devices 5100 and a corresponding one of the second connecting devices 5200, and the female terminal 5101 of the corresponding one of the first connecting device 5100 and the male terminal of the corresponding one of the second connecting device 5200 are connected to each of the lampshades by a locking component 5500.

Each of the light-emitting bodies 5300 is connected between a corresponding one of the first connecting devices 5100 and a corresponding one of the second connecting devices 5200. The male terminal 5330 of each of the light-emitting bodies 5300 is detachably plugged with the female terminal 5101 of each of the first connecting devices 5100. When the male terminal 5330 of each of the light-emitting bodies 5300 is plugged with the female terminal 5101 of the first connecting device 5100, the electrode elements 5331 of the male terminal 5330 of each of the light-emitting bodies 5300 are electrically connected to the electrode elements 5116 of the female terminal 5101 of each of the first connecting devices 5100. Specifically, the male terminal 5330 of each of the light-emitting bodies 5300 comprises two electrode elements 5331, such as a positive electrode element and a negative electrode element. The female terminal 5101 of each of the first connecting devices 5100 comprises two electrode elements 5116, such as a positive electrode element and a negative electrode element. The positive electrode element of the male terminal 5330 of each of the light-emitting bodies 5300 is electrically connected to the positive electrode element of the female terminal 5101 of the corresponding one of the first connecting devices 5100, and the negative electrode element of the male terminal 5330 of each of the light-emitting bodies 5300 is electrically connected to the negative electrode element of the female terminal 5101 of the corresponding one of the first connecting devices 5100.

The male terminal 5340 of each of the light-emitting bodies 5300 is detachably plugged with the male terminal 5201 of each of the second connecting devices 5200. When the male terminal 5340 of each of the light-emitting bodies is plugged with the male terminal 5201 of a corresponding one of the second connecting devices 5200, the electrode elements (5344) of the female terminal 5340 of each of the light-emitting bodies 5300 are electrically connected to the electrode elements 5216 of the male terminal 5201 of each of the second connecting devices 5200. Specifically, the female terminal 5340 of each of the light-emitting bodies 5300 comprises two electrode elements 5344, such as a positive electrode element and a negative electrode element. The male terminal 5201 of each of the second connecting devices 5200 comprises two electrode elements 5216, such as a positive electrode element and a negative electrode element. The positive electrode element of the female terminal 5340 of each of the light-emitting bodies 5300 is electrically connected to the positive electrode element of the male terminal 5201 of the corresponding one of the second connecting devices 5200, and the negative electrode element of the female terminal 5340 of each of the light-emitting bodies 5300 is electrically connected to the negative electrode element of the male terminal 5201 of the corresponding one of the second connecting devices 5200.

The female terminal 5101 of one of the first connecting devices 5100 serves as a signal input end of the lamp 10S. For example, the female terminal 5101 of a first one of the first connecting devices 5100 is electrically connected to an electrical plug 5700 via a wire 5102, and the electrical plug 5700 is connected to the mains power.

Optionally, the female terminal 5101 of each of the first connecting devices 5100 and the male terminal 5201 of each of the second connecting devices 5200 comprise an inner connecting portion (5112, 5212) and an outer connecting portion (5111, 5211) connected to the inner connecting portion (5112, 5212). Each of the lampshades 5400 further comprises a first mounting plate 5440 disposed at the first opening 5410 thereof, a second mounting plate 5450 disposed at the second opening 5420 thereof, a first mounting groove 5460 communicated with the first opening 5410 thereof, and a second mounting groove 5470 communicated with the second opening 5420 thereof. Each inner connecting portion (5112, 5212) is disposed in the first opening 5410 or the second opening 5420 of a corresponding one of the lampshades 5400 and is limited by the first mounting plate 5440 or the second mounting plate 5450 of the corresponding one of the lampshades 5400. Each outer connecting portion (5111, 5211) is disposed in the first mounting groove 5460 or the second mounting groove 5470 of a corresponding one of the lampshades 5400 and is stopped by the first mounting plate 5440 or the second mounting plate 5450 of the corresponding one of the lampshades 5400. Each outer connecting portion (5111, 5211) is connected to the first mounting plate 5440 or the second mounting plate 5450 of the corresponding one of the lampshades 5400 through a corresponding locking component 5500.

Each locking component 5500 is, for example, a screw or a bolt. Each outer connecting portion 5111 comprises a locking hole 5103, each outer connecting portion 5211 comprises a locking hole 5203, and each first mounting plate 5440 and each second mounting plate 5450 both have locking holes 5401. Each first locking component 5500 is mounted into corresponding locking holes 5103 and 5401 to lock a corresponding one of the first connecting devices 5100 to a corresponding one of the lampshades 5400, and each second locking component 5500 is mounted into corresponding locking holes 5203 and 5401 to lock a corresponding one of the second connecting devices 5200 and a corresponding one of the lampshades 5400.

Optionally, an outer diameter of each inner connecting portion (5112, 5212) is less than an outer diameter of each outer connecting portion (5111, 5211). In this way, a stepped structure is formed between each inner connecting portion (5112, 5212) and a corresponding outer connecting portion (5111, 5211).

Optionally, both of each first mounting plate 5440 and each second mounting plate 5450 define at least one limiting groove 5480 disposed on a peripheral side thereof. At least one limiting structure 5219 is disposed on an outer side surface of each inner connecting portion (5112, 5212), and each limiting structure 5219 is disposed in a corresponding limiting groove 5480, thereby limiting a rotation of each of the first connecting devices 5100 relative to the corresponding one of the lampshades 5400 and limiting a rotation of each of the second connecting devices 5200 relative to the corresponding one of the lampshades 5400.

Optionally, both of an outer side surface of the first mounting plate 5440 and an outer side surface of the second mounting plate 5450 define a waterproof groove 5400. The lamp further comprises waterproof pads 5600. Each of the waterproof pads 5600 is disposed in a corresponding waterproof groove 5400. Each of the waterproof pads 5600 is disposed between the first mounting plate 5440 or the second mounting plate 5450 of a corresponding one of the lampshade 5400 and a corresponding outer connecting portion (5111, 5211). Optionally, each of the lampshades 5400 further comprises limiting rings 5402 respectively disposed on the first mounting plate thereof 5440 and the second mounting plate thereof 5450. Each limiting groove 5480 is stopped at a position of a corresponding one of the limiting rings 5402.

Optionally, the female terminal 5101 of each of the first connecting devices 5100 comprises the insulating component 5110. The insulating component 5110 comprises a plug-in end surface 5114 and electrode grooves 5115 penetrating the plug-in end surface 5114. The electrode elements 5116 of each female terminal 5101 are one-to-one disposed within the electrode grooves 5115 of a corresponding insulating component 5110, and a distance between any one of the electrode elements 5116 of each female terminal 5101 and the plug-in end surface 5114 of the corresponding insulating component 5110 is greater than 0, so as to limit the electrode elements 5116 of each female terminal 5101 in the electrode grooves 5115 of the corresponding insulating component 5110. During the gold finger detection process, the electrode elements 5116 of the female terminal 5101 are not touched. Optionally, the female terminal 5101 of each of the first connecting devices 5100 further comprises a plug-in portion 5113 connected to the inner connecting portion 5112 thereof, and the inner connecting portion 5112 thereof is connected between the outer connecting portion 5111 thereof and the plug-in portion 5113 thereof. For each insulating component 5110, the plug-in end surface 5114 thereof is disposed on one end of the plug-in portion 5113 thereof away from the inner connection portion 5112 thereof, and the corresponding electrode grooves 5115 are at least partially formed in the plug-in portion 5113 thereof.

Optionally, for each of the first connecting devices 5100, an outer diameter of the plug-in portion 5113 thereof is less than an outer diameter of the inner connecting portion 5112 thereof and an outer diameter of the outer connecting portion 5111 thereof, so that the plug-in portion 5113 thereof is allowed to be plugged into the accommodating space 5130 of a corresponding one of the lampshades 5400 from the first opening 5410 or the second opening 5420 of the corresponding one of the lampshade 5400.

Optionally, the male terminal 5201 of each of the second connecting devices 5200 further comprises a sleeve 5213, the sleeve 5213 thereof is connected to the inner connecting portion 5212 thereof, and the inner connecting portion 5213 thereof is connected between the outer connecting portion 5211 thereof and the sleeve 5213 thereof. Each sleeve 5213 defines a plugging space 5215. The electrode elements 5216 of each male terminal 5201 are disposed in the plugging space 5215 of a corresponding sleeve 5213. That is, the electrode elements 5216 of each male terminal 5201 are surrounded by the corresponding sleeve 5213, and the electrode elements 5216 are spaced apart from an inner surface of the corresponding sleeve 5213. The plugging space 5215 of each sleeve 5213 further accommodates a portion of the female terminal 5340 of each of the light-emitting bodies 5300. For each of the second connecting devices 5200, an outer diameter of the sleeve 5213 thereof is less than an outer diameter of the inner connecting portion 5212 thereof and an outer diameter of the outer connecting portion 5211 thereof, so that the sleeve 5213 thereof is allowed to be plugged into the accommodating space 5130 of a corresponding one of the lampshades 5400 from the first opening 5410 or the second opening 5420 of the corresponding one of the lampshade 5400.

Optionally, the female terminal 5340 of each of the light-emitting bodies 5300 comprises the insulating component 5341. The insulating component 5341 comprises a plug-in end surface 5342 and electrode grooves 5343 penetrating the plug-in end surface 5342. The electrode elements 5344 of each female terminal 5340 are one-to-one disposed within the electrode grooves 5343 of a corresponding insulating component 5341. A distance between any one of the electrode elements 5344 of each female terminal 5340 and the plug-in end surface 5342 of the corresponding insulating component 5341 is greater than 0, so as to limit the electrode elements 5344 of each female terminal 5340 in the electrode grooves 5343 of the corresponding insulating component 5341 During the gold finger detection process, the electrode elements 5344 of the female terminal 5340 are not touched. For each of the light-emitting bodies 5300, the insulating component 5341 thereof and the electrode elements 5344 of the female terminal 5340 thereof are partially plugged into the plugging space 5215 of a corresponding male terminal 5201 to achieve an electrical connection between the electrode elements 344 thereof and the electrode elements 5216 of the corresponding male terminal 5201.

Optionally, the electrode elements 5331 of the male terminal 5330 of each of the light-emitting bodies 5300 may be exposed or at least partially disposed in the insulating component 5332 thereof.

In some optional embodiments, for each of the light-emitting bodies 5300, the rigid circuit board 5310 thereof and the one or more light-emitting elements 5320 thereof are disposed in the insulating component 5332 thereof and the insulating component 5341 thereof, and the insulating components 5332 thereof and the insulating component 5341 thereof are connected together.

Optionally, the outer side surface of the plug-in portion 5113 comprises an arc-shaped surface 5117 and a flat surface 5118, and the arc-shaped surface 5117 and the flat surface 5118 are connected to each other. In other alternative embodiments, the outer side surface of the plug-in portion 5113 may have other structures, such as a circular structure.

Optionally, the outer side surface of each sleeve 5213 comprises an arc-shaped surface 5217 and a flat surface 5218.

Optionally, each female terminal of the lamp 10S is configured as a signal input end of a corresponding male terminal plugged with the female terminal.

Optionally, each of the first connecting devices 5100 and each of the second connecting devices 5200 are connected between corresponding two adjacent lampshades 5400 and are directly or indirectly connected. For instance, each two adjacent first connecting device 5100 and second connecting device 5200 are physically and electrically connected through wires 5102 and 5202.

In the above embodiments, an arrangement order of all male and female terminals of the lamp is as follows: starting from one end of the electrical plug, female terminal, male terminal, female terminal, male terminal, female terminal, male terminal, female terminal, male terminal, female terminal, male terminal.

In the above embodiments, the electrodes elements of each female terminal are wrapped in the insulating material and are disposed in the insulating material, so that the electrode elements of each female terminal of the lamp are not touched during the gold finger detection process.

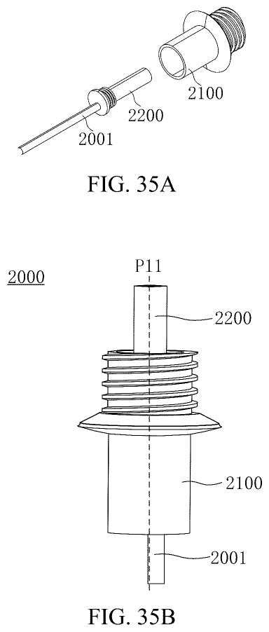

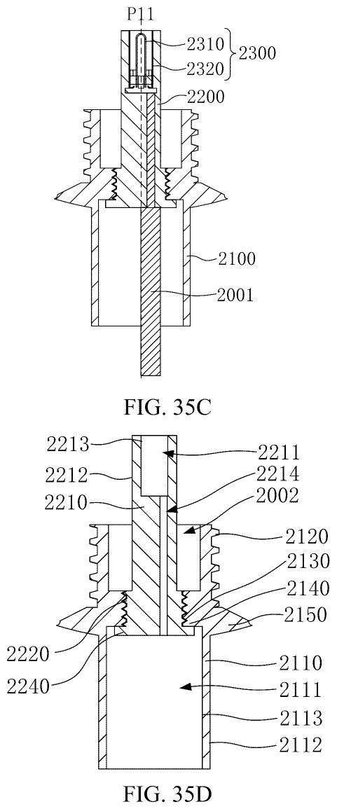

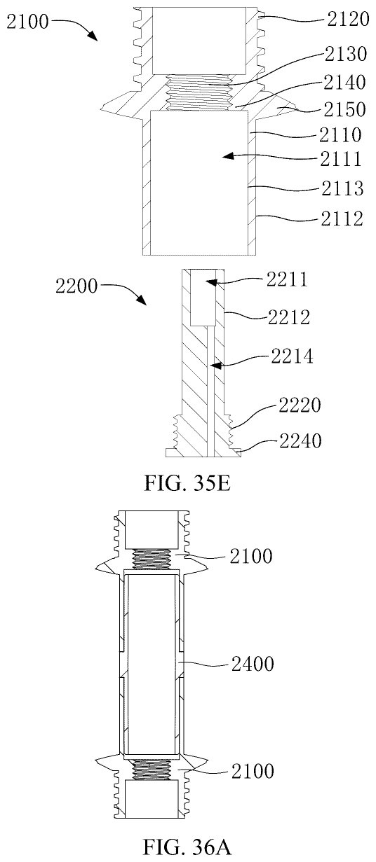

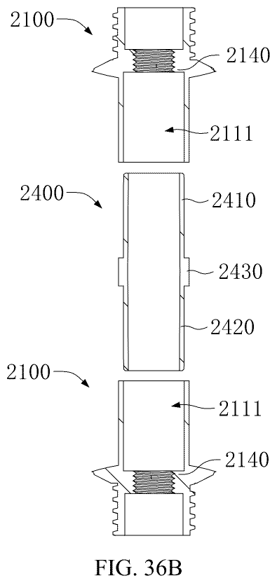

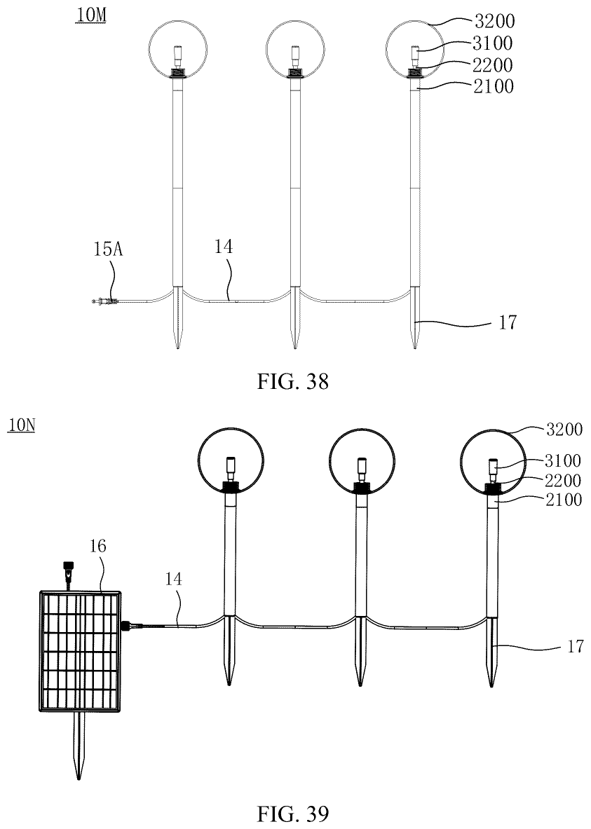

In other optional embodiments, as shown in FIGS. 35A-40, the embodiments further provide a connecting device 2000 and a lamp (10L, 10M, 10N, 10P) having the connecting device 2000. The connecting device 2000 includes a first connecting component 2100, a second connecting component 2200, and an electrical connecting terminal 2300. The first connecting component 2100, the second connecting component 2200, and the electrical connecting terminal 2300 are rotatable around the same axis, such as an eleventh axis P11.

The first connecting component 2100 includes a first connecting body 2110, a first outer connecting structure 2120, and a first inner connecting structure 2130. The first connecting body 2110 is hollow and includes a channel 2111. The channel 2111 penetrates through two end faces of the first connecting body 2110 along the eleventh axis P11. The first connecting body 2110 further includes an outer surface 2112 and an inner surface 2113. The first outer connecting structure 2120 is disposed on the outer surface 2112 of the first connecting body 2110, and the first inner connecting structure 2130 is disposed on the inner surface 2113 of the first connecting body 2110.

The second connecting component 2200 comprises a second connecting body 2210 and a second outer connecting structure 2220. The second outer connecting structure 2220 is disposed on an outer surface 2102 of the second connecting body 2210. The second connecting component 2200 comprises a mounting groove 2211 disposed on the second connecting body 2210.

A first portion of the second connecting body 2210 and the second outer connecting structure 2220 are disposed in the first connecting body 2110, and a second portion of the second connecting body 2210 is disposed outside the first connecting body 2110. The first inner connecting structure 2130 and the second outer connecting structure 2220 are connected.

At least a portion of the electrical connecting terminal 2300 is disposed in the mounting groove 2211 of the second connecting body 2210. The electrical connecting terminal 2300 comprises electrode elements with different polarities. For instance, the electrical connecting terminal 2300 comprises a first electrode element 2310 and a second electrode element 2320. The first electrode element 2310 and the second electrode element 2320 have different polarities, such as the first electrode element 2310 is a positive electrode element and the second electrode element 2320 is a negative electrode element. It should be noted that both of the first electrode element 2310 and the second electrode element 2320 of the electrical connecting terminal 2300 are electrically connected to a wire, such as a wire 2001. The wire 2001 is configured to electrically connect to other components, such as an electrical plug 15A, an electrical plug 15B, a solar panel component 16, etc. The second connecting body 2210 defines a wire hole 2214. The wire hole 2214 is communicated with the mounting groove 2211. The wire 2001 is partially placed in the wire hole 2214, and the wire 2001 passes through the wire hole 2214 to electrically connected to the first electrode element 2310 and the second electrode element 2320 of the electrical connecting terminal 2300.

In one optional embodiment, when the first electrode element 2310 and the second electrode element 2320 of the electrical connecting terminal 2300 are coaxially disposed, one of the electrode elements of the electrical connecting terminal 2300, such as the second electrode element 2320, is disposed on an inner surface 2213 of the second connecting body 2210. The inner surface 2213 defines the mounting groove 2211.

In practical applications, one end of the second connecting component 2200 with the electrical connecting terminal 2300 is first plugged from one end of the first connecting component 2100 into a channel 2111 of the first connecting component 2100. Then, the one end of the second connecting component 2200 with the electrical connecting terminal 2300 extends from a second end of the first connecting component 2100. The user is able to hold the first connecting component 2100 with one hand and the second connecting component 2200 with the other hand to connect the first inner connecting structure 2130 and the second outer connecting structure 2220 together, thereby achieving a connection between the first connecting component 2100 and the second connecting component 2200.

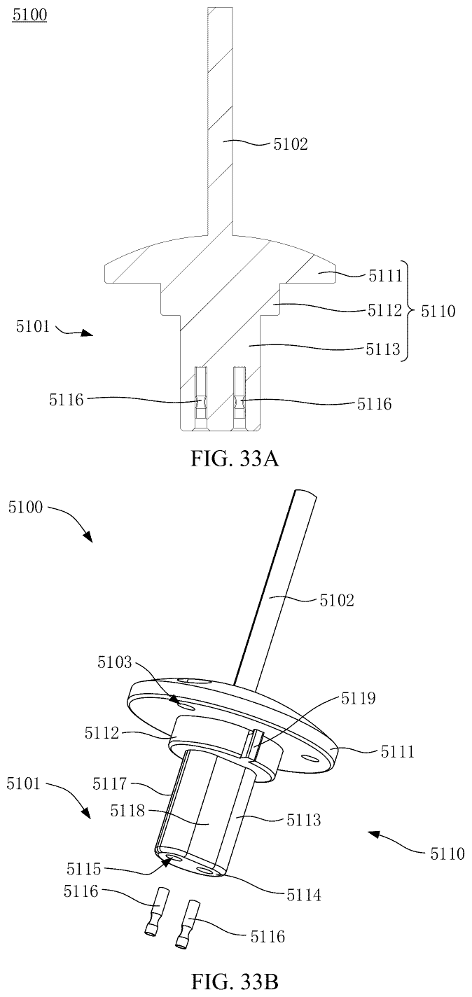

In some optional embodiments, the electrode elements (2310, 2320) of the electrical connecting terminal 2300 are coaxially disposed. For instance, the first electrode element 110A and the second electrode element 120 shown in FIGS. 1A, 1B, 1C, and 1D are coaxially disposed. In other alternative embodiments, the electrode elements (2310, 2320) of the electrical connecting terminal 2300 are not coaxially disposed. For instance, the first electrode element 4121 and the second electrode element 4122 shown in FIGS. 31A, 31B, and 31C are not coaxially disposed, and the electrode elements 5116 shown in FIG. 33A are not coaxially disposed. It should be noted that when the electrode elements (2310, 2320) of the electrical connecting terminal 2300 are coaxially disposed, the electrode elements (2310, 2320) are separated by at least one insulating layer, which may be referred to as the spacer 131 and is not described in detail herein. In other alternative embodiments, when the electrode elements (2310, 2320) of the electrical connecting terminal 2300 are coaxially disposed, the electrode elements (2310, 2320) are spaced apart through the air. When there is an insulating layer between the electrode elements (2310, 2320), the connecting device 2000 is able to be applied to AC or DC power. When the electrode elements (2310, 2320) are spaced apart through the air, the connecting device 2000 is able to be applied to DC power.

Optionally, the first inner connecting structure 2130 is detachably connected to the second outer connecting structure 2220, which facilitates disassembly of the connecting device 20000 and makes transportation and storage convenient.

Optionally, the first inner connecting structure 2130 comprises a connecting thread, the second outer connecting structure 2220 comprises a connecting thread, and the first connecting component 2100 and the second connecting component 2200 are allowed to be screwed with each other. It should be noted that a threaded connection of the first connecting component 2100 and the second connecting component 2200 facilitates assembly and disassembly of the first connecting component 2100 and the second connecting component 2200, and the threaded connection of the first connecting component 2100 and the second connecting component 2200 makes the first connecting component 2100 and the second connecting component 2200 waterproof, so that the first connecting component 2100 and the second connecting component 2200 are allowed to be used in outdoor environments. It should further be noted that the first inner connecting structure 2130 and the second outer connecting structure 2220 may be connected by other methods, and additional waterproof structures or components may be provided if waterproofing is required. For example, the first inner connecting structure 2130 and the second outer connecting structure 2220 may be connected by snapping fasteners or screws. A connection state of the first connecting component 2100 and the second connecting component 2200 is shown in FIGS. 35B, 35C and 35D, and in a separated state of the first connecting component 2100 and the second connecting component 2200 is shown in FIGS. 35A and 35E.

In one optional embodiment, the first connecting component 2100 further comprises a first stop structure 2140, and the second connecting component 2200 further comprises a second stop structure 2240. The first stop structure 2140 is disposed on an inner side 2113 of the first connecting body 2110, and the first inner connecting structure 2130 is disposed on the first stop structure 2140. The second stop structure 2240 is disposed on an outer side 2212 of the second connecting body 2210, and the second outer connecting structure 2220 and the second stop structure 2240 are disposed adjacent to each other. When the first connecting component 2100 is connected to the second connecting component 2200, the first stop structure 2140 and the second stop structure 2240 are adjacent to each other or are attached to each other. The first stop structure 2140 and the second stop structure 2240 are configured to limit a position of the second connecting component 2200.

Optionally, the inner side 2113 of the first connecting body 2110 and the outer side 2212 of the second connecting body 2210 are spaced apart from each other. The inner side 2113 of the first connecting body 2110 and the outer side 2212 of the second connecting body 2210 jointly define a plugging space 2002. The first outer connecting structure 2120 is disposed around the plugging space 2002. The plugging space 2002 is configured to accommodate other components. For example, during a plugging process with the electrical connecting terminal 2300, a first portion of the other component is sleeved on the outer side 2212 of the second connecting body 2210 and a second portion of the other component is plugged into the plugging space 2002.

Optionally, the first outer connecting structure 2120 is disposed close to one end of the first connecting body 2110. When the first connecting component 2100 is connected to the second connecting component 2200, a portion of the second connecting body 2210 extends from the one end of the first connecting component 2100 where the first outer connecting structure 2120 is disposed.

Optionally, the first connecting component 2100 further comprises a sealing structure 2150. The sealing structure 2150 is disposed on the outer surface 2112 of the first connecting body 2110. The sealing structure 2150 is disposed adjacent to the first outer connecting structure 2120, and the sealing structure 2150 is disposed close to a middle portion of the first connecting body 2110.

Optionally, the first outer connecting structure 2120 may comprise a threaded structure. For example, the first outer connecting structure 2120 is defined as a first outer thread. The first outer connecting structure 2120 is configured to detachably connect to a connecting structure disposed at an opening of a lampshade of a lamp.

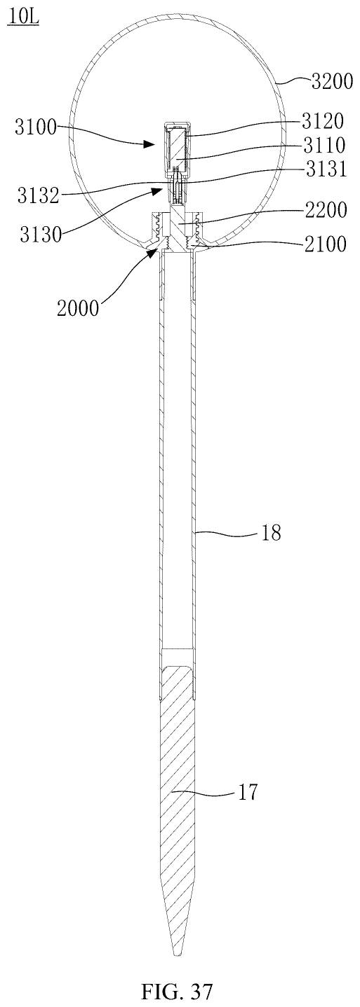

In one optional embodiment, as shown in FIGS. 37, 38 and 39, the lamp (10L, 10M, 10N) comprises one or more light-emitting elements 3100, one or more lampshades 3200, and one or more connecting devices 2000.

Each lampshade 3200 comprises an opening and an accommodating space communicated with the opening. Each lampshade 3200 further comprises a connecting structure disposed at the opening. As shown in FIGS. 29A and 29B, each lampshade 3200 may be referenced to the lampshade 500A. The opening, accommodating space and connecting structure of lampshade 3200 may be referenced to the first opening 510, the accommodating space 530 and the first internal thread 540, which are not described in detail herein.

Each light-emitting body 3100 comprises a rigid circuit board 3110, one or more light-emitting elements 3220 electrically connected to the rigid circuit board 3110, and an electrical connecting terminal 3130 physically and electrically connected to the rigid circuit board 3110. The electrical connecting terminal 3130 of each light-emitting body 3100 comprises at least two electrode elements, such as a third electrode element 3131 and a fourth electrode element 3132. The third electrode element 3131 and the fourth electrode element 3132 of each light-emitting body 3100 have different polarities. For instance, the third electrode element 3131 is a positive electrode element and the fourth electrode element 3132 is a negative electrode element. It is understood that the third electrode element 3131 and the fourth electrode element 3132 of each light-emitting body 3100 are coaxially disposed or are not coaxially disposed. When the third electrode element 3131 and the fourth electrode element 3132 of each light-emitting body 3100 are coaxially disposed, the third electrode element 3131 and the fourth electrode element 3132 of each light-emitting body 3100 may refer to the third electrode element 210 and the fourth electrode element 220A or the fourth electrode element 220B. It should be noted that when the third electrode element 3131 and the fourth electrode element 3132 of each light-emitting body 3100 are coaxially disposed, there is an insulating component between the third electrode element 3131 and the fourth electrode element 3132, or portions of the third electrode element 3131 and the fourth electrode element 3132 are insulated through air. When the third electrode element 3131 and the fourth electrode element 3132 of each light-emitting body 3100 are not coaxially disposed, the third electrode element 3131 and the fourth electrode element 3132 of each light-emitting body 3100 may refer to the electrode elements (4231 and 4232).

Each light-emitting body 3100 may refer to the light-emitting body (400A, 400B, 400C, 400D, 400E, 400F, 400M), which is not described in detail herein.

Optionally, the electrical connecting terminal 2300 of one of the one or more connecting devices 2000 is pluggable with the electrical connecting terminal 3130 of the one of the one or more light-emitting bodies 3100. The first outer connecting structure 2120 of the one of the one or more connecting devices 2000 is connected to a connecting structure, such as the internal thread 540 at the opening 510 of one of the one or more lampshades 3200. When the electrical connecting terminal 2300 of the one of the one or more connecting devices 2000 and the electrical connecting terminal 3130 of one of the one or more light-emitting bodies 3100 are in the plugged-in state, the electrical connecting terminal 2300 of the one of the one or more connecting devices 2000. The electrode elements (2310, 2320) are electrically connected to the electrode elements (3131, 3132) of the electrical connecting terminal 3130 of the one of the one or more light-emitting bodies 3100. For instance, the positive electrode element of the electrical connecting terminal 2300 of the one of the one or more connecting devices 2000 is electrically connected to the positive electrode element of the electrical connecting terminal 3130 of the one of the one or more light-emitting bodies 3100, and the negative electrode element of the electrical connecting terminal 2300 of the one of the one or more connecting devices 2000 is electrically connected to the negative electrode element of the electrical connecting terminal 3130 of the one of the one or more light-emitting bodies 3100.

The first connecting component 2100, the second connecting component 2200, and the electrical connecting terminal 2300 of each connecting device 2000 are rotatable together around the same axis, such as the eleventh axis P11, relative to a corresponding lampshade 3200. Each connecting device 2000 and a corresponding light-emitting body 3100 are rotatable together around the same axis, such as the eleventh axis P11, relative to the corresponding lampshade 3200, or each connecting device 2000 is rotatable relative to the corresponding lampshade 3200 and a corresponding light-emitting body 3100. In practical applications, the electrical connecting terminal 3130 of each light-emitting body 3100 and the electrical connecting terminal 2300 of a corresponding connecting device 2000 are plugged together to achieve electrical connection therebetween. Then, each light-emitting body 3100 and a portion of the corresponding connecting device 2000 are plugged from the opening 510 of the corresponding lampshade 3200 into the accommodating space 530 of the corresponding lampshade 3200. Then, each connecting device 2000 and the corresponding lampshade 3200 are driven to rotate relative to each other, so as to connect the first outer connecting structure 2120 (e.g., outer thread) of each connecting device 2000 and the connecting structure (e.g., internal thread 540) of the corresponding lampshade 3200 together. Thus, in one optional embodiment of the present disclosure, the first outer connecting structure 2120 of each connecting device 2000 comprises a connecting thread, and the connecting structure at the opening 510 of each lampshade 3200 comprises a connecting thread (i.e., the internal thread 540). The first outer connecting structure 2120 of each connecting device 20000 is detachably screwed with the connecting structure at the opening 510 of the corresponding lampshade 3200. For instance, each lampshade 3200 further comprises a mounting groove 560 communicated with the opening 510, and the sealing structure 2150 of the first connecting component 2100 of each connecting device 2000 is disposed in the mounting groove 560 of the corresponding lampshade. An outer surface of the sealing structure 2150 of each connecting device 2000 and an outer surface of the corresponding lampshade 3200 are smoothly transitioned.

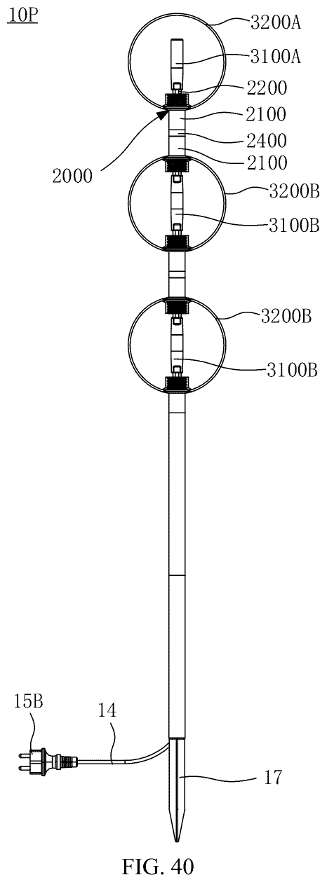

In one optional embodiment, as shown in FIG. 40, the lamp 10P comprises light-emitting bodies (3100A and 3100B), lampshades (3200A and 3200B), and connecting devices 2000.

Each of the lampshades 3200A may refer to each lampshade 3200 or the lampshade 500A, which is not described herein.

Each of the lampshades 3200B comprises a first opening, a second opening, and an accommodating space communicating with the first opening and the second opening. Each of the lampshades further comprises a second inner connecting structure disposed at the first opening and a third inner connecting structure disposed at the second opening. Each of the lampshades 3200B may refer to the lampshade 500B. The first opening, the second opening, and the accommodating space of each of the lampshades 3200B may refer to the first opening 510, the second opening 520, and the accommodating space 530 of the lampshade 500B. The second inner connecting structure may refer to the first internal thread 540, and the third inner connecting structure may refer to the second internal thread 550, which are not described in detail herein.

The second inner connecting structure at the first opening of each of the lampshades 3200B is connected to the first outer connecting structure 2120 of a corresponding connecting device 2000, and the third inner connecting structure at the second opening of each of the lampshades 3200B is connected to the first outer connecting structure 2120 of another connecting device 2000.

The light-emitting body 3100A may refer to each light-emitting body 3100, which is not described in detail herein.

Each of the light-emitting bodies 3100B comprises a rigid circuit board, one or more light-emitting elements electrically connected to the rigid circuit board, and two electrical connecting terminals physically and electrically connected to the rigid circuit board. The electrical connecting terminal of each of the light-emitting bodies 3100B comprises at least two electrode elements. Each of the light-emitting bodies 3100B may refer to light-emitting body 400G, 400H, 400J, 400K, and 400L, which is not described in detail herein.

The electrical connecting terminal of each of the light-emitting bodies 3100B is detachably plugged with the electrical connecting terminal 2300 of a corresponding connecting device 2000. When the electrical connecting terminal 2300 of each of the connecting devices 2000 is plugged into the electrical connecting terminal of a corresponding light-emitting body 3100B, the electrode elements (2310, 2320) of the electrical connecting terminal 2300 of each connecting device 2000 are correspondingly electrically connected to the electrode elements of the electrical connecting terminal of the corresponding light-emitting body 3100B.

Two connecting devices 2000 are connected between two adjacent lampshades 3200B or two adjacent lampshades (3200A and 3200B). The two connecting devices 2000 located between the two lampshades 3200B or the two lampshades (3200A and 3200B) are directly or indirectly connected.

The first connecting component 2100, the second connecting component 2200, and the electrical connecting terminal 2300 of each of the connecting devices 2000 are rotatable together around the same axis relative to the corresponding lampshade (3200A and 3200B). Each of the connecting devices 2000 and the corresponding light-emitting body 3100A are rotatable together around the same axis relative to the corresponding lampshade 3200A, or each of the connecting devices 2000 is rotatable relative to the corresponding lampshade 3200B and the corresponding light-emitting body 3100B.

The lamp 10P further comprises third connecting components 2400. Each of the third connecting component 2400 comprises connecting portions. A connecting portion of the first connecting component is sleeved on the first connecting component 2100 of another connecting device 2000. Specifically, each of the third connecting components 2400 comprises a first connecting portion 2410, a second connecting portion 2420, and a stop portion 2430, and the first connecting portion 2410, the second connecting portion 2420, and the stop portion 2430 are connected sequentially. In each of the third connecting components 2400, an outer diameter of the stop portion 2430 is greater than an outer diameter of the first connecting portion 2410 and an outer diameter of the second connecting portion 2420, and the outer diameter of the first connecting portion 2410 is equal to the outer diameter of the second connecting portion 2420. Each first connecting body 2110 is sleeved on a corresponding first connecting portion 2410 or a corresponding second connecting portion 2420 and is stopped at a corresponding stop portion 2430.

In one embodiment, the electrode elements (2310, 2320) of the electrical connecting terminal 2300 of each of the connecting devices 2000 are coaxially disposed, and the electrode elements (3131, 3132) of the electrical connecting terminal 3130 of each of the light-emitting bodies 3100 are coaxially disposed. In another embodiment, the electrode elements (2310, 2320) of the electrical connecting terminals 2300 of each of the connecting devices 2000 are not coaxially disposed, and the electrode elements (3131, 3132) of the electrical connecting terminals 3130 of each of the light-emitting bodies 3100 are not coaxially disposed.

In the embodiment, the electrode elements (2310, 2320) of the electrical connecting terminal 2300 of each of the connecting devices 2000 are allowed to be connected to AC or DC power. For example, the electrode elements (2310, 2320) of each electrical connecting terminal 2300 are electrically connected to the wire 14, and the wire 14 is electrically connected to the electrical plug 15A or the electrical plug 15B, where the electrical plug 15A is configured to be connected to the AC power. In other alternative embodiments, a transformer is electrically connected between the electrical plug 15A or the electrical plug 15B and a corresponding connecting device 2000, so that the electrode elements (2310, 2320) of the electrical connecting terminal 2300 of each of the connecting devices 2000 are allowed to connect to the DC power. In other alternative embodiments, the connecting device 2000 is electrically connected to the solar panel 16 via the wire 14, and the solar panel 16 is capable of providing direct current to the electrode elements (2310, 2320) of the electrical connecting terminals 2300 of each of the connecting devices 2000.

The electrode elements (2310, 2320) of the electrical connecting terminal 2300 of one of the connecting devices 2000 are directly electrically connected to the electrical plug 15A or the electrical plug 15B; or, the electrode elements (2310, 2320) of the electrical connecting terminal 2300 of the one of the connecting devices 2000 are electrically connected to the electrical plug 15A or the electrical plug 15B via the transformer or, the electrode elements (2310, 2320) of the electrical connecting terminal 2300 of the one of the connecting devices 2000 are electrically connected to the solar panel 16.

The lamps (10L, 10M, 10N, and 10P) further comprise one or more ground spikes 17. Each ground spike 17 is directly or indirectly physically connected to the first connecting component 2100 of a corresponding connecting device 2000. For example, each ground spike 17 and a corresponding first connecting component 2100 are connected by a sleeving tube 18. Each ground spike 17 is sleeved in the corresponding sleeving tube 18r, and one end of the first connecting component 2100 away from each light-emitting body 3100 is sleeved on a corresponding sleeving tube 18. There can be one or more sleeving tubes 18. When there are sleeving tubes 18, the sleeving tubes are allowed to be connected end to end. It should be noted that each ground spike 17 is sleeved in the corresponding first connecting component 2100. Each ground spike 17 is able to be spiked into the ground, and a lamp with the one or more ground spikes 17, such as the lamp (10L, 10M, 10N, and 10P), is called a ground lamp. It should be noted that the first connecting component 2100 of the one or more connecting devices 2000 may further be connected to other components, such as a hanging component, a ceiling component, a base, etc. The lamp with the hanging component is called a pendant lamp, a chandelier, or a wall lamp. The lamp with the ceiling component is called a ceiling lamp. The lamp with the base is called a desk lamp or a floor lamp. It should further be noted that the lamp with the one or more connecting devices 2000 may further be used in other scenarios, such as being placed in liquids, such as in a river, which is not described in detail herein.

Optionally, the threads of the first inner connecting structure 2130 and the first outer connecting structure 2120 are either opposite or identical.

In one optional embodiment, one of the connecting components of each connecting device 2000 is connected to the corresponding light-emitting body, and the other one of the connecting components of each connecting device 2000 is connected to the corresponding lampshade, which facilitates user operation in some cases.

What is claimed is:

1. A lamp powered by mains power, comprising:
at least one light-emitting body (4200);
at least one lampshade (4300); and
at least one connecting device (4100);
wherein the at least one lampshade (4300) comprises an opening (4310) and an accommodating space (4330) communicated with the opening (4310);
wherein the at least one light-emitting body (4200) comprises a rigid circuit board (4210), at least one light-emitting elements (4220) electrically connected to the rigid circuit board (4210), a male terminal (4230) physically and electrically connected to the rigid circuit board (4210); wherein the male terminal (4230) comprises electrode elements (4231, 4232);
wherein the at least one connecting device (4100) comprises a female terminal (4101);
wherein the female terminal (4101) comprises a female base (4110) and electrode elements (4121, 4122), the female base (4110) is made of an insulating material, and the electrode elements (4121, 4122) of the female terminal (4101) are disposed in the female base (4110) and are spaced apart by an insulating structure in the female base (4110), and the female terminal (4101) is connectable to and separable from the at least one lampshade (4300);
wherein the female base (4110) comprises a plug-in end surface (4114) and two electrode grooves (4115) penetrating through the plug-in end surface (4114), the electrode elements of the female terminal (4101) are one-to-one disposed in the electrode grooves (4115), and a distance between any one of the electrode elements of the female terminal (4101) and the plug-in end surface (4114) of the female terminal (4101) is greater than 0, so that the electrode elements (4121, 4122) of the female terminal (4101) are respectively limited inside the electrode grooves (4115) of the female base (4110);
wherein the electrode elements (4231, 4232) of the male terminal (4230) are detachably plugged with the electrode elements (4121, 4122) of the female terminal (4101);
wherein when the electrode elements (4231, 4232) of the male terminal (4230) are plugged with the electrode elements (4121, 4122) of the female terminal (4101), the electrode elements (4231, 4232) of the male terminal (4230) are respectively electrically connected to the electrode elements (4121, 4122) of the female terminal (4101).

2. The lamp according to claim 1, wherein the at least one lampshade (4300) further comprises an internal thread (4340) disposed at the opening (4310), the female terminal (4101) further comprises an outer thread (4112) disposed on an outer side surface thereof, and the outer thread (4112) of the female base (4110) is configured to be screwed with the internal thread (4340) of the at least one lampshade (4300);
wherein when the electrode elements (4231, 4232) of the male terminal (4230) are plugged with the electrode elements (4121, 4122) of the female terminal (4101), the at least one light-emitting body (4200) and the at least one connecting device (4100) are rotatable together around an axis (P10).

3. The lamp according to claim 2, wherein the at least one lampshade (4300) further comprises a mounting groove communicated with the opening (4310), the female terminal (4101) further comprises a mounting portion (4113), the mounting portion (4113) is adjacent to the outer thread (4112), and when the internal thread (4340) is screwed with the outer thread (4112), the mounting portion (4113) is mounted in the mounting groove.

4. The lamp according to claim 1, wherein the female terminal (4101) comprises an outer thread (4112) and a mounting portion (4113), and the female base (4110) comprises a plug-in portion (4111);
wherein the plug-in portion (4111), the outer thread (4112), and the mounting portion (4113) are sequentially disposed along an axis direction of the female terminal (4101);
wherein the plug-in end surface (4114) of the female terminal (4101) is disposed on one end of the plug-in portion (4111) away from the outer thread (4112), and the outer thread (4112) and the mounting portion (4113) are disposed on an outer side surface of the female base (4110);
wherein an outer diameter of the plug-in portion (4111), an outer diameter of the outer thread (4112), and an outer diameter of the mounting portion (4113) sequentially increase;
wherein the at least one lampshade (4300) further comprises an internal thread (4340) disposed at the opening (4310), and the internal thread (4340) is screwed with the outer thread (4112);
wherein the at least one lampshade (4300) further comprises a mounting groove communicated with the opening (4310), and the mounting portion (4113) is mounted in the mounting groove when the inner thread (4340) is screwed with the outer thread (4112).

5. The lamp according to claim 4, wherein the outer side surface of the plug-in portion (4111) comprises an arc-shaped surface (4116) and a flat surface (4117), and the arc-shaped surface (4116) and the flat surface (4117) are connected to each other.

6. A lamp powered by mains power, comprising:
light-emitting bodies (5300);
lampshade (5400);
first connecting devices (5100); and
second connecting devices (5200);
wherein each of the lampshades (5400) comprises a first opening (5410), a second opening (5420), and an accommodating space (5430) communicated with the first opening (5410) and the second opening (5420);
wherein each of the light-emitting bodies (5300) comprises a rigid circuit board (5310), one or more light-emitting elements (5320) electrically connected to the rigid circuit board (5310), a female terminal (5340), and a male terminal (5330); wherein the female terminal (5340) thereof and the male terminal (5330) thereof are physically connected to and electrically connected to the rigid circuit board (5310) thereof;
wherein both of the female terminal (5340) and the male terminal (5330) of each of the light-emitting bodies (5300) comprise two electrode elements, and the electrode elements (5331,5344) of the female terminal (5340) of each of the light-emitting bodies (5300) are disposed in a first insulating structure;
wherein each of the first connecting devices (5100) comprises a female terminal (5101), the female terminal (5101) of each of the first connecting devices (5100) comprises electrode elements (5116), and the electrode elements (5116) of the female terminal (5101) of each of the first connecting devices (5100) are disposed in a first insulating structure;
wherein each of the second connecting devices (5200) comprise a male terminal (5201), and the male terminal (5201) of each of the second connecting devices (5200) comprises electrode elements (5216);
wherein each of the lampshades (5400) is connected between a corresponding one of the first connecting devices (5100) and a corresponding one of the second connecting devices (5200), and the female terminal (5101) of the corresponding one of the first connecting device (5100) and the male terminal of the corresponding one of the second connecting device (5200) are connected to each of the lampshades by a locking component;
wherein each of the light-emitting bodies (5300) is connected between a corresponding one of the first connecting devices (5100) and a corresponding one of the second connecting devices (5200), the male terminal (5330) of each of the light-emitting bodies (5300) is detachably plugged with the female terminal (5101) of each of the first connecting devices (5100), and when the male terminal (5330) of each of the light-emitting bodies (5300) is plugged with the female terminal (5101) of the first connecting device (5100), the electrode elements (5331) of the male terminal (5330) of each of the light-emitting bodies (5300) are electrically connected to the electrode elements (5116) of the female terminal (5101) of each of the first connecting devices (5100);
wherein the male terminal (5340) of each of the light-emitting bodies (5300) is detachably plugged with the male terminal (5201) of each of the second connecting devices (5200), and when the male terminal (5340) of each of the light-emitting bodies is plugged with the male terminal (5201) of a corresponding one of the second connecting devices (5200), the electrode elements (5344) of the female terminal (5340) of each of the light-emitting bodies (5300) are electrically connected to the electrode elements (5216) of the male terminal (5201) of each of the second connecting devices (5200);
wherein the female terminal (5101) of one of the first connecting devices (5100) serves as a signal input end of the lamp.

7. The lamp according to claim 6, wherein both of the female terminal (5101) of each of the first connecting devices (5100) and the male terminal (5201) of each of the second connecting devices (5200) comprise an inner connecting portion (5112, 5212) and an outer connecting portion (5111, 5211) connected to the inner connecting portion (5112, 5212);
wherein each of the lampshades (5400) further comprises a first mounting plate (5440) disposed at the first opening (5410) thereof, a second mounting plate (5450) disposed at the second opening (5420) thereof, a first mounting groove (5460) communicated with the first opening (5410) thereof, and a second mounting groove (5470) communicated with the second opening (5420) thereof;
wherein each inner connecting portion (5112, 5212) is disposed in the first opening (5410) or the second opening (5420) of a corresponding one of the lampshades (5400) and is limited by the first mounting plate (5440) or the second mounting plate (5450) of the corresponding one of the lampshades (5400);
wherein each outer connecting portion (5111, 5211) is disposed in the first mounting groove (5460) or the second mounting groove (5470) of a corresponding one of the lampshades (5400) and is stopped by the first mounting plate (5440) or the second mounting plate (5450) of the corresponding one of the lampshades (5400), and each outer connecting portion (5111, 5211) is connected to the first mounting plate (5440) or the second mounting plate (5450) of the corresponding one of the lampshades (5400) through a corresponding locking component (5500).

8. The lamp according to claim 7, wherein an outer diameter of each inner connecting portion (5112, 5212) is less than an outer diameter of each outer connecting portion (5111, 5211).

9. The lamp according to claim 7, wherein both of each first mounting plate (5440) and each second mounting plate (5450) define at least one limiting groove (5480) disposed on a peripheral side thereof;
wherein at least one limiting structure (5219) is disposed on an outer side surface of each inner connecting portion (5112, 5212), and each limiting structure (5219) is disposed in a corresponding limiting groove (5480).

10. The lamp according to claim 7, wherein both of an outer side surface of each first mounting plate (5440) and an outer side surface of each second mounting plate (5450) define a waterproof groove (5490), the lamp further comprises waterproof pads (5600), each of the waterproof pads (5600) is disposed in a corresponding waterproof groove (5490), and each of the waterproof pads (5600) is disposed between the first mounting plate (5440) or the second mounting plate (5450) of a corresponding one of the lampshade (5400) and a corresponding outer connecting portion (5111, 5211).

11. The lamp according to claim 7, wherein the female terminal (5101) of each of the first connecting devices (5100) further comprises a plug-in portion (5113) connected to the inner connecting portion (5112) thereof, and the inner connecting portion (5112) thereof is connected between the outer connecting portion (5111) thereof and the plug-in portion (5113) thereof;
wherein for each of the first connecting devices (5100), an outer diameter of the plug-in portion (5113) thereof is less than an outer diameter of the inner connecting portion (5112) thereof and an outer diameter of the outer connecting portion (5111) thereof, and the electrode elements (5116) of the female terminal (5101) thereof are disposed in the plug-in portion (5113) thereof.

12. The lamp according to claim 7, wherein the male terminal (5201) of each of the second connecting devices (5200) further comprises a sleeve (5213), the sleeve (5213) thereof is connected to the inner connecting portion (5212) thereof, and the inner connecting portion (5213) thereof is connected between the outer connecting portion (5211) thereof and the sleeve (5213) thereof;
wherein for each of the second connecting devices (5200), an outer diameter of the sleeve (5213) thereof is less than an outer diameter of the inner connecting portion (5212) thereof and an outer diameter of the outer connecting portion (5211) thereof, and the electrode elements (5216) of the male terminal (5201) thereof are enclosed by the sleeve (5213) thereof and are spaced apart from an inner side surface of the sleeve (5213) thereof.

13. The lamp according to claim 6, wherein both of the female terminal (5340) of each of the light-emitting bodies (5300) and the female terminal (5101) of each of the first connecting devices (5100) comprise an insulating component (5341,5110); wherein each insulating component (5341,5110) comprises a plugging end surface (5342,5114) and electrode grooves (5343, 5115) penetrating through the plugging end surface (5342,5114); and the electrode elements of the female terminal (5340, 5101) of each of the light-emitting bodies (5300) are one-to-one disposed in the electrode grooves (5343, 5115) of each insulating component (5341,5110);
wherein a distance between any one of the electrode elements and the plugging end surface (5342,5114) of each female terminal (5340, 5101) is greater than 0, so as to limit the electrode elements of each female terminal (5340, 5101) inside the electrode grooves (5343, 5115) of a corresponding insulating component (5341,5110).

14. The lamp according to claim 6, wherein each female terminal (5340, 5101) is configured as a signal input end of a corresponding male terminal (5330, 5201) plugged with the female terminal (5340, 5101).

15. The lamp according to claim 6, wherein each of the first connecting devices (5100) and each of the second connecting devices (5200) are connected between corresponding two adjacent lampshades (5400) and are directly or indirectly connected.
